(19) United States
(12) Patent Application Publication
(10) Pub. No.: US 2005/0251844 A1
(43) Pub. Date: Nov. 10, 2005

(54) Blind correlation for high precision ranging of coded OFDM signals

(76) Inventors: Massimiliano Martone, Antioch, CA (US); James J. Spilker JR., Woodside, CA (US); Jimmy K. Omura, San Franncisco, CA (US); Matthew Rabinowitz, Portola Valley, CA (US)

Correspondence Address: LAW OFFICE OF RICHARD A. DUNNING, JR., 343 SOQUEL AVENUE, SUITE 311, SANTA CRUZ, CA, 95062, US

(21) Appl. No.: 11/068,570

(22) Filed: Feb. 28, 2005

Related U.S. Application Data
(63) Continuation-in-part of application No. 10/867,577, filed on Jun. 14, 2004.
Application No. 10/867,577 is a continuation of application No. 10/210,847, filed on Jul. 31, 2002, now Pat. No. 6,861,984.
Application No. 10/210,847 is a continuation of application No. 09/887,158, filed on Jun. 21, 2001, now abandoned.
(63) Continuation-in-part of application No. 09/932,010, filed on Aug. 17, 2001.
(63) Continuation-in-part of application No. 10/290,984, filed on Nov. 8, 2002.
(63) Continuation-in-part of application No. 10/796,790, filed on Mar. 8, 2004, now abandoned.
Application No. 10/796,790 is a continuation of application No. 10/209,578, filed on Jul. 31, 2002, now Pat. No. 6,753,812.
Application No. 10/209,578 is a continuation of application No. 10/054,262, filed on Jan. 22, 2002, now abandoned.
(63) Continuation-in-part of application No. 10/159,478, filed on May 31, 2002.
(63) Continuation-in-part of application No. 10/747,851, filed on Dec. 29, 2003, now Pat. No. 6,859,173.
Application No. 10/747,851 is a continuation of application No. 10/232,142, filed on Aug. 29, 2002, now Pat. No. 6,717,547.
(60) Provisional application No. 60/633,151, filed on Dec. 2, 2004.
(60) Provisional application No. 60/265,675, filed on Feb. 2, 2001.
(60) Provisional application No. 60/281,270, filed on Apr. 3, 2001.
(60) Provisional application No. 60/281,269, filed on Apr. 3, 2001.
(60) Provisional application No. 60/293,812, filed on May 25, 2001.
(60) Provisional application No. 60/293,813, filed on May 25, 2001.
(60) Provisional application No. 60/293,646, filed on May 25, 2001.
(60) Provisional application No. 60/361,762, filed on Mar. 4, 2002.
(60) Provisional application No. 60/353,440, filed on Feb. 1, 2002.
(60) Provisional application No. 60/332,504, filed on Nov. 13, 2001.
(60) Provisional application No. 60/378,819, filed on May 7, 2002.
(60) Provisional application No. 60/361,762, filed on Mar. 4, 2002.
(60) Provisional application No. 60/329,592, filed on Oct. 15, 2001.
(60) Provisional application No. 60/315,983, filed on Aug. 29, 2001.

(51) Int. Cl. H04B 1/707; H04B 1/69; H04N 7/173; H04B 7/204; H04B 1/713

(52) U.S. Cl. 725/118; 370/319; 725/126; 375/148

(57) ABSTRACT

An apparatus having a corresponding method and computer program comprises a front end to receive an orthogonal frequency division modulation (OFDM) signal comprising a plurality of OFDM symbols each comprising N samples and a cyclic prefix comprising M of the N samples, wherein M<N; a buffer to store the cyclic prefix for one of the OFDM symbols; and a correlator to generate a correlation output based on the cyclic prefix and the one of the OFDM symbols.

### CROSS-REFERENCE TO RELATED APPLICATIONS

This application claims the benefit of U.S. Provisional Patent Application Ser. No. 60/633,151, “Blind Correlation for High Precision Ranging of Coded OFDM Signals,” by Martone, et al., filed Dec. 2, 2004.

This application is a CIP of Ser. No. 10/867,577 Jun. 14, 2004, which is a CON of Ser. No. 10/210,847 Jul. 31, 2002, which is a CON of Ser. No. 09/887,158 Jun. 21, 2001, which claims the benefit of 60/265,675 Feb. 02, 2001, and claims the benefit of 60/281,270 Mar. 03, 2001, and claims the benefit of 60/281,269 Mar. 03, 2001, and claims the benefit of 60/293,812 May 25, 2001, and claims the benefit of 60/293,813 May 25, 2001, and claims the benefit of 60/293,646 May 25, 2001, and claims the benefit of 60/309,267 Jul. 31, 2001, and claims the benefit of 60/344,988 Dec. 20, 2001.

This application is a CIP of Ser. No. 09/932,010 Aug. 17, 2001.

This application is a CIP of Ser. No. 10/290,984 Nov. 08, 2002.

This application is a CIP of 10/796,790 Mar. 08, 2004, which is a CON of U.S. Pat. No. 6,753,812 Jun. 22, 2004, which is a CON of Ser. No. 10/054,262 Jan. 22, 2002.

This application is a CIP of Ser. No. 10/159,478 May 31, 2002, which claims the benefit of 60/361,762 Mar. 04, 2002, and claims the benefit of 60/353,440 Feb. 01, 2002, and claims the benefit of 60/332,504 Nov. 13, 2001.

This application is a CIP of Ser. No. 10/747,851 Dec. 29, 2003, which is a CON of Ser. No. 10/232,142 Apr. 6, 2004, which claims the benefit of 60/378,819 May 07, 2002, and claims the benefit of 60/361,762 Mar. 04, 2002, and claims the benefit of 60/329,592 Oct. 15, 2001, and claims the benefit of 60/315,983 Aug. 29, 2001.

The subject matter of all of the foregoing are incorporated herein by reference.

### BACKGROUND

The present invention relates generally to signal processing, and particularly to blind correlation for high precision ranging of coded orthogonal frequency division modulation (OFDM) signals.

### SUMMARY

In general, in one aspect, the invention features an apparatus comprising: a front end to receive an orthogonal frequency division modulation (OFDM) signal comprising a plurality of OFDM symbols each comprising N samples and a cyclic prefix comprising M of the N samples, wherein M<N; a buffer to store the cyclic prefix for one of the OFDM symbols; and a correlator to generate a correlation output based on the cyclic prefix and the one of the OFDM symbols.

Some embodiments comprise a synchronizer to identify boundaries of the OFDM symbols. Some embodiments comprise an accumulator to accumulate the correlation output for a plurality of the OFDM symbols. In some embodiments, the correlator comprises: a fast Fourier transform (FFT) engine. In some embodiments, the correlator generates frequency-domain representations of the one of the OFDM symbols and the cyclic prefix for the one of the OFDM symbols, generates a product of the frequency-domain representations; and generates a time-domain representation of the product. In some embodiments, a location of the apparatus is determined based upon the correlation output. Some embodiments comprise a ranging unit to determine a location of the apparatus based upon the correlation output. Some embodiments comprise a demodulator to demodulate the OFDM signal based upon the correlation output. In some embodiments, the OFDM signal comprises at least one of the group consisting of: a European Telecommunications Standards Institute (ETSI) Digital Video Broadcasting-Terrestrial (DVB-T) signal; a ETSI Digital Video Broadcasting-Handheld (DVB-H) signal; and a Japanese Integrated Services Digital Broadcasting-Terrestrial (ISDB-T) signal.

In general, in one aspect, the invention features a method comprising: receiving an orthogonal frequency division modulation (OFDM) signal comprising a plurality of OFDM symbols each comprising N samples and a cyclic prefix comprising M of the N samples, wherein M<N; storing the cyclic prefix for one of the OFDM symbols; and generating a correlation output based on the cyclic prefix and the one of the OFDM symbols.

Some embodiments comprise identifying boundaries of the OFDM symbols. Some embodiments comprise accumulating the correlation output for a plurality of the OFDM symbols. In some embodiments, generating a correlation output based on the cyclic prefix and the one of the OFDM symbols comprises: generating frequency-domain representations of the one of the OFDM symbols and the cyclic prefix for the one of the OFDM symbols; generating a product of the frequency-domain representations; and generating a time-domain representation of the product. In some embodiments, a location is determined based upon the correlation output. Some embodiments comprise determining a location based upon the correlation output. Some embodiments comprise demodulating the OFDM signal based upon the correlation output. In some embodiments, the OFDM signal comprises at least one of the group consisting of: a European Telecommunications Standards Institute (ETSI) Digital Video Broadcasting-Terrestrial (DVB-T) signal; a ETSI Digital Video Broadcasting-Handheld (DVB-H) signal; and a Japanese Integrated Services Digital Broadcasting-Terrestrial (ISDB-T) signal.

In general, in one aspect, the invention features a apparatus comprising: front end means for receiving an orthogonal frequency division modulation (OFDM) signal comprising a plurality of OFDM symbols each comprising N samples and a cyclic prefix comprising M of the N samples, wherein M<N; buffer means for storing the cyclic prefix for one of the OFDM symbols; and correlator means for generating a correlation output based on the cyclic prefix and the one of the OFDM symbols.

Some embodiments comprise means for identifying boundaries of the OFDM symbols. Some embodiments comprise means for accumulating the correlation output for a plurality of the OFDM symbols. In some embodiments, the correlator means comprises: means for performing a fast Fourier transform (FFT). In some embodiments, the correlator means generates frequency-domain representations of the one of the OFDM symbols and the cyclic prefix for the one of the OFDM symbols, generates a product of the frequency-domain representations; and generates a time-domain representation of the product. Some embodiments comprise a location of the apparatus is determined based upon the correlation output. Some embodiments comprise means for determining a location of the apparatus based upon the correlation output. Some embodiments comprise means for demodulating the OFDM signal based upon the correlation output. In some embodiments, the OFDM signal comprises at least one of the group consisting of: a European Telecommunications Standards Institute (ETSI) Digital Video Broadcasting-Terrestrial (DVB-T) signal; a ETSI Digital Video Broadcasting-Handheld (DVB-H) signal; and a Japanese Integrated Services Digital Broadcasting-Terrestrial (ISDB-T) signal.

In general, in one aspect, the invention features a computer program for an apparatus, the computer program comprising: storing a cyclic prefix for one of a plurality of orthogonal frequency division modulation (OFDM) symbols received by the apparatus, wherein each of the OFDM symbols comprises N samples and a cyclic prefix comprising M of the N samples, wherein M<N; and generating a correlation output based on the cyclic prefix and the one of the OFDM symbols. Some embodiments comprise identifying boundaries of the OFDM symbols. Some embodiments comprise accumulating the correlation output for a plurality of the OFDM symbols. In some embodiments, generating a correlation output based on the cyclic prefix and the one of the OFDM symbols comprises: generating frequency-domain representations of the one of the OFDM symbols and the cyclic prefix for the one of the OFDM symbols; generating a product of the frequency-domain representations; and generating a time-domain representation of the product. In some embodiments, a location of the apparatus is determined based upon the correlation output. Some embodiments comprise determining a location of the apparatus based upon the correlation output. Some embodiments comprise demodulating the OFDM signal based upon the correlation output. In some embodiments, the OFDM signal comprises at least one of the group consisting of: a European Telecommunications Standards Institute (ETSI) Digital Video Broadcasting-Terrestrial (DVB-T) signal; a ETSI Digital Video Broadcasting-Handheld (DVB-H) signal; and a Japanese Integrated Services Digital Broadcasting-Terrestrial (ISDB-T) signal.

The details of one or more implementations are set forth in the accompanying drawings and the description below. Other features will be apparent from the description and drawings, and from the claims.

### DESCRIPTION OF DRAWINGS

FIG. 1 is a block diagram of the TV-GPS location technology according to a preferred embodiment of the present invention.

FIG. 2, which shows a functional block diagram of the baseband signal processing of an OFDM system that employs IFFT/FFT.

FIG. 3 shows an implementation of a correlator.

FIG. 4 shows the typical output of the correlator in response to an ISDB-T Coded OFDM signal (Mode 1, 1405 subcarriers, 2K FFT).

FIG. 5 shows a Van de Beek synchronizer output for an ISDB-T Coded OFDM signal after symbol-synchronous integration of about 30 symbols.

FIG. 6 shows a scheme for finding symbol boundaries.

FIG. 7 shows simulation results for an ISDB-T 6 MHz waveform for Mode 1.

FIG. 8 shows simulation results for an OFDM signal at an intermediate frequency of about 90 MHz.

FIG. 9 shows an FFT-based demodulation of one of the coherent 64-QAM segments.

FIG. 10 shows an FFT-based demodulation where the five segments have 16-QAM.

FIG. 11 shows an FFT-based demodulation where the five segments have coherent QPSK.

FIG. 12 shows examples of one-symbol envelope of the correlator outputs.

FIG. 13 shows examples of five-symbol envelope of the correlator outputs with coherent integration of five symbols.

FIG. 14 shows an example at low SNR (approximately 5 dB) with 2K FFT for Mode 1 ISDB-T where the Cyclic Prefix is ¼.

The output envelope of the novel self-correlator as more and more OFDM symbols are coherently integrated is shown in FIG. 15.

FIG. 16 shows the integration SNR loss caused by the noise x noise effect.

FIG. 17 shows the behavior of the ambiguity function of the T/4 cyclically prefixed OFDM signal.

The main elements of the ranging system are illustrated in FIG. 18.

FIG. 19 shows data flows in the ranging system.

FIG. 20 shows a timing diagram.

FIG. 21 shows a functional block diagram of a correlator based on a two-buffer approach according to a preferred embodiment of the present invention.

FIG. 22 shows a high-level timing diagram for the correlator of FIG. 21.

FIG. 23 shows the computational complexity of a “self-matched” filter in the time domain and in the frequency domain, with emphasis on the computational advantage of a frequency domain convolution approach.

FIG. 24 shows the conceptual operation of a frequency domain filter according to a preferred embodiment of the present invention.

FIG. 25 shows a schematic summary of frequency domain matched filter operation.

FIG. 26 shows a single-chip ASIC architecture of a correlator according to a preferred embodiment of the present invention.

FIG. 27 shows a process 2700 for the correlator of FIG. 26 according to a preferred embodiment.

FIG. 28 shows the salient characteristics of FPGA devices.

FIG. 29 shows a block diagram of a symbol synchronizer according to a preferred embodiment.

FIG. 30 shows a FFT engine with triple memory operation according to a preferred embodiment.

FIG. 31 shows a timing diagram for the FFT core assuming an example with N=32.

The leading digit(s) of each reference numeral used in this specification indicates the number of the drawing in which the reference numeral first appears.

### DETAILED DESCRIPTION

The market of integrated positioning and navigation systems is clearly dominated by those systems that have the Global Positioning System (GPS) as their main component. Besides being globally available, GPS provides a satisfactory range of navigation accuracies at very low cost. It is also highly portable, has relatively low power consumption, and is well suited for integration with other sensors, communication links, and databases. The main drawback of GPS technology is that GPS is capable of providing positioning and navigation parameters only in situations where uninterrupted and unobstructed satellite signal reception is possible. The need for alternative positioning systems arises because GPS does not work satisfactorily in indoor or obstructed environments.

The use of broadcast television (TV) signals to augment an Assisted GPS (AGPS) solution has been advocated by Rosum Corporation, and is described in detail in U.S. Non-provisional patent applications Ser. No. 10/867,577 filed Jun. 14, 2004, Ser. No. 09/932,010 filed Aug. 17, 2001, and Ser. No. 10/290,984 filed Nov. 08, 2002, the subject matter thereof being incorporated herein by reference. The innovative concept is to exploit the high-powered TV infrastructure to obtain ranging anywhere even state of the art AGPS solutions are not able to receive reliable satellite signal levels. Moreover TV signals are broadband signals of bandwidth much larger than that of the civil GPS C/A code thereby permitting in principle a higher accuracy tracking operation. Rosum Corporation has deployed the first generation system that exploits ATSC/NTSC TV signals and is therefore functional across North America.

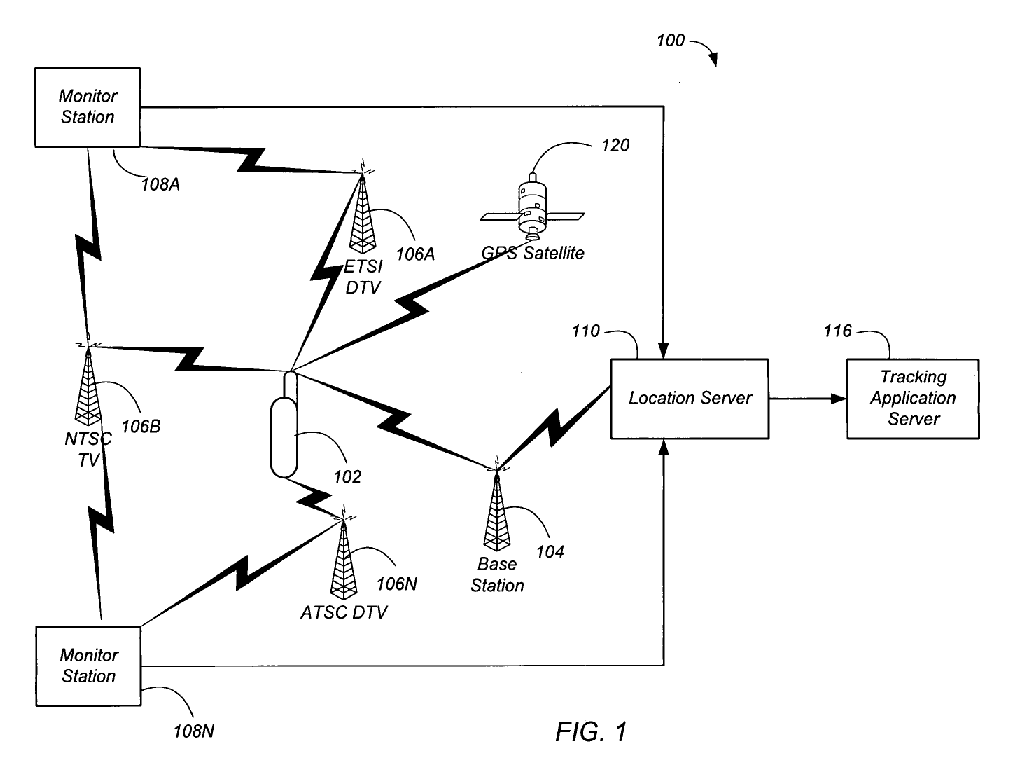

FIG. 1 is a block diagram of the TV-GPS location technology according to a preferred embodiment of the present invention. TV stations 106 broadcast TV signals. Regional monitor stations 108 analyze the TV signals and send channel stability and timing information to a location server 110. Location server 110 sends aiding information to a Ranging Television Measurement Module (RTMM) located in a user device 102. The RTMM receives the TV signals and GPS signals from one or more GPS satellites 120, measures their timing, computes pseudoranges, and sends this information to location server 110, for example via a base station 104. Location server 110 computes the position of the RTMM, and sends this information back to the RTMM, or to a tracking application server 116. Alternatively, the RTMM can compute its location.

One aspect of implementing the technique for other TV standards is presented by the fact that both Europe and Japan have adopted a multicarrier waveform of the Orthogonal Frequency Division Multiplexing (OFDM) type. Traditional single-carrier digital modulations incorporate known and repetitive waveform patterns that allow time domain correlation and Time of Arrival (ToA) estimation, as described in U.S. Pat. No. 6,522,297, issued Feb. 18, 2003; U.S. Pat. No. 6,559,800, issued May 6, 2003; U.S. Pat. No. 6,717,547, issued Apr. 6, 2004; U.S. Pat. No. 6,727,847, issued Apr. 27, 2004; and U.S. Pat. No. 6,753,812, issued Jun. 22, 2004; the subject matter thereof being incorporated herein by reference.

Neither the European standard DVB-T nor the Japanese ISDB-T signals embed time-domain reference patterns. The problem is significant, because even though pilots are embedded in the frequency domain representation of the waveform, the time-frequency resolution of such pilots is not robust to clock variation effects caused by receiver and transmitter local oscillator instability.

Multicarrier techniques transmit data by dividing the stream into several parallel bit streams. Each of the subchannels has a much lower bit rate and is modulated onto a different carrier. OFDM is a special case of multicarrier modulation with equally spaced subcarriers and overlapping spectra. The OFDM time-domain waveforms are chosen such that mutual orthogonality is ensured in the frequency domain. Time dispersion is easily handled by such systems because the substreams are essentially free of intersymbol interference (ISI). To force the ISI-free nature of the waveform all wideband OFDM systems are circularly prefixed.

A coarsification of the time-frequency grid is typically employed using a guard-time between temporal adjacent symbols for mitigation of the time-dispersive characteristic of a frequency selective channel. Both the European DVB and ISDB-T inject a Cyclic Prefix in the OFDM symbol that introduces significant signal redundant information. The inventors have recognized that this redundant information can be used for synchronization for ranging, demodulation, and other signal processing.

The duration of the cyclic prefix depends on the expected severity of the multipath, but in any event can be by specification ¼, ⅛, 1/16, 1/32 of the full OFDM symbol for both European and Japanese broadcast systems. This means that technically a significant portion of the signal (in fact 1/32, 1/16, ⅛, ¼) can be used for ranging and accurate positioning without any significant implementation complexity or risk. While the cyclic prefix has been reportedly used for OFDM symbol synchronization purposes (for example, in Van de Beek, J. J.; Sandell, M.; Borjesson, P. O.; “ML estimation of time and frequency offset in OFDM systems,” IEEE Transactions on Signal Processing, Volume: 45, Issue: 7, July 1997), the typical apparatus employed to obtain coarse symbol synchronization is not suitable for accurate ranging. The following discussion emphasizes that the cyclic prefix correlator disclosed by Van de Beek is not the optimal ToA estimator because the method is unable to discriminate time delays to the maximum extent allowed by the bandwidth of the TV signal.

In contrast, the techniques disclosed herein are able to discriminate time delay from a Multicarrier waveform to the maximum extent allowed by the bandwidth of the TV signal.

Waveform Description

The baseband equivalent transmitted signal in a generic N-channel multicarrier system is expressed as

$$s ( t ) = {\sum }_{k = - ∞}^{+ ∞} {\sum }_{l = 0}^{N - 1} {a}_{k , l} {ϕ}_{k , l} ( t ) = {\sum }_{k = - ∞}^{+ ∞} {\sum }_{l = 0}^{N - 1} {a}_{k , l} {ϕ}_{l} ( t - {kT}_{s} ) , \qquad ( 1 )$$

where Tₛ is the symbol period a_{k,l} is the information-bearing symbol, and φ_{k,l}(t)=φₗ(t−kTₛ), l=0, 1, . . . , N-1 are the fundamental basis waveforms. The transmitted signal s(t) is linearly distorted by the multipath fading channel operator H as in

$$y ( t ) = ( Hs ) ( t ) = {\sum }_{k = - ∞}^{+ ∞} {\sum }_{l = 0}^{N - 1} {a}_{k , l} {f}_{k , l} ( t ) = {\sum }_{k = - ∞}^{+ ∞} {\sum }_{l = 0}^{N - 1} {a}_{k , l} {f}_{l} ( t - {kT}_{s} ) \qquad ( 2 )$$

where fₗ(t)=(Hφₗ)(t).

The fundamental problem is to select the transmission basis φ_{k,l}(t)=φₗ(t−kT) in such a way that the projection of the signal onto the signal set φ_{k,l}(t) in absence of noise gives the transmitted symbols up to a complex gain βₗ

$${z}_{k , l} = {\int }_{- ∞}^{+ ∞} y ( t ) {ϕ}_{k , l}^{*} ( t ) ⅆ t = {\int }_{- ∞}^{+ ∞} y ( t ) {ϕ}_{l}^{*} ( t - {kT}_{s} ) ⅆ t = {β}_{l} {a}_{k , l} .$$

This condition implies not only relative simplicity of the receiver but also robustness to additive white Gaussian noise in the sense of a capacity-achieving design. The transmission basis employed in multicarrier systems is
φ_{k,l}(t)=g(t−kTₛ)e^{j2πlFt}, (3)

where F is the carrier frequency spacing and g(t) is a shaping window. The use of pulses as in equation (3) results in a rectangular tiling of the time-frequency plane. The product TₛF≧1 defines the time-frequency product of each independent function in the signal set. In the OFDM case the pulse g(t) in equation (3) is a rectangular window of duration Tₛ and F=1/Tₛ. A coarsification of the time-frequency grid is typically employed using a guard-time between temporal adjacent symbols for mitigation of the time-dispersive characteristic of a frequency selective channel. However, properly shaping the basic symbols in each subchannel by using a pulse different from the rectangular one mitigates frequency dispersion effects of the channel caused by Doppler spreads. If the channel is perfectly static with Fourier transform H(f),

$$g ( t ) = \{ \begin{matrix}\frac{1}{\sqrt{{T}_{s}}} & 0 \leq t \leq {T}_{s} \\ 0 & elsewhere\end{matrix} \} ,$$

and the guard-time is long enough to cover for the support of the channel, one obtains

$${z}_{k , l} = {\int }_{- ∞}^{+ ∞} y ( t ) g ( t - kT ) {ⅇ}^{- j2π l Ft} ⅆ t = H ( lF ) {a}_{k , l} + {n}_{k , l} \qquad ( 4 )$$

for l=0, 2, . . . , N-1 and k=−∞, . . . , 0, . . . +∞. At any given k arranging N samples in N-vectors gives
z(k)=Λ_{H}a(k)+n(k) (5)

where Λ_{H} is a diagonal matrix with generic lth diagonal element H(lF), and the organization of z_{k,l}, a_{k,l}, and n_{k,l} in the vectors z(k), a(k) and n(k), respectively, is clear from the context. Multicarrier transmission with N subcarriers is supposed to asymptotically approach C as subcarrier spacing BlN=F decreases and N increases. Assuming that Pₛ^{(o)}(f) and

$$\frac{{\vert H ( f ) \vert}^{2}}{N ( f )}$$

are flat within F, at each carrier fᵢ, the capacity of the generic ith subchannel is

$${C}_{i} = F {log}_{2} [ 1 + {P}_{s}^{( o )} ( {f}_{i} ) \frac{{\vert H ( {f}_{i} ) \vert}^{2}}{N ( {f}_{i} )} ] ,$$

so that the aggregate rate is Σᵢ₌₁^{N}Cᵢ, and ΣᵢCᵢ [symbol] C as N→∞. The superscript^{(o)} indicates that the power assigned to the particular subcarrier obeys the water-filling solution. In practice the projection operations are implemented by DFT-based transformations. This is exactly the point that makes OFDM an attractive practical technique. Assuming that Tₛ=RT_{S} for R positive integer, equation (1) can be written as

$$s ( t ) = {\sum }_{k = - ∞}^{+ ∞} {\sum }_{l = 0}^{N - 1} {a}_{k , l} {ϕ}_{l} ( t - {kRT}_{S} ) .$$

Sampling at Tₑ≦Tₛ yields

$${s}_{k} ( n ) = {\sum }_{m = - ∞}^{+ ∞} {\sum }_{l = 0}^{N - 1} {a}_{m , l} {ϕ}_{l} ( ( nN - mR ) {T}_{S} - {kT}_{e} )$$

with sₖ(n)=s((nR−k)Tₑ), k=0, 1, . . . , N-1 where R is such that RTₑ=NT_{S}. The particular case R=N and Tₑ=T_{S}, φ₁(t)=g(t)e^{2πjf}^{ₗ}^{t},

$$g ( t ) = \{ \begin{matrix}\frac{1}{\sqrt{{NT}_{S}}} & 0 \leq t \leq {NT}_{S} \\ 0 & elsewhere\end{matrix} \} , and {f}_{l} = \frac{1}{{NT}_{S}}$$

collapses to an FFT-based multicarrier system

$$\begin{matrix}{s}_{k} ( n ) = {\sum }_{m = - ∞}^{+ ∞} {\sum }_{l = 0}^{N - 1} {a}_{m , l} g ( ( n - m ) {NT}_{S} - {kT}_{S} ) exp \{ \frac{j2π lk}{N} \} \\ = \frac{1}{\sqrt{{NT}_{S}}} {\sum }_{l = 0}^{N - 1} {a}_{n - 1 , l} exp \{ \frac{j2π lk}{N} \} .\end{matrix} \qquad ( 6 )$$

By defining
a(n)=[a_{n-1,0},a_{n-1,1}, . . . , a_{n-1,N-1}]^{T}

and
s(n)=[s₀(n), s₁(n), . . . , s_{N-1}(n)]^{T},

equations (6) can be rewritten in vector form as
s(n)=Fa(n), (7)

where F represents the (orthonormal) mapping (i.e., the k,l element of F is

$$( i . e . , the k , l element of F is \frac{1}{\sqrt{N}} exp \{ \frac{j2π lk}{N} \} )$$

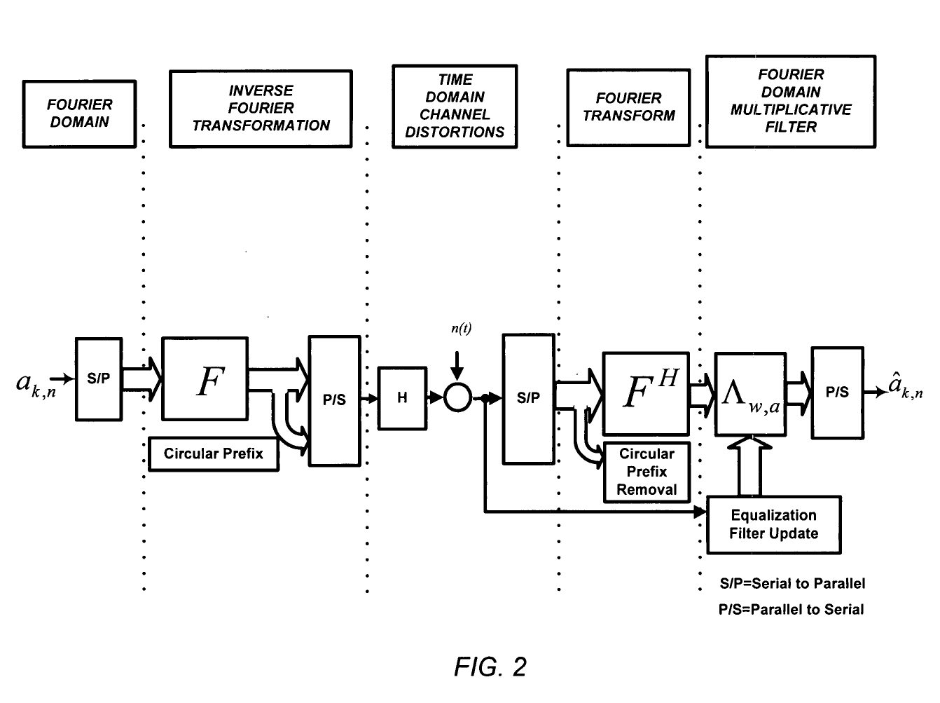

of the inverse Fourier transform and we have assumed without loss of generality a unitary sample period T_{S}. Similarly at the receiver the received baseband samples can be collected in a vector r(n) and the transformation F^{H} applied. It is possible to show that if data are properly cyclically prefixed the channel convolution will appear as a cyclic convolution and diagonalization of the channel is achieved, just like the ideal multicarrier scheme. The modeling assumptions described can be summarized as in FIG. 2, which shows a functional block diagram of the baseband signal processing of an OFDM system that employs IFFT/FFT. The transformation F is the basic discrete Fourier transform (DFT) matrix.

Synchronizer

As observed above, the cyclic prefix enables perfect diagonalization of the multipath channel in the frequency domain at the expense of a slight throughput degradation. In fact this diagonalization property makes OFDM a waveform with extreme robustness to frequency selective multipath channels. It has been observed by many researchers that the injection of the cyclic prefix creates a spectrally redundant waveform. One clever practical ramification of this observation was exploited by van de Beek, Sandell and Borjesson, who reported a symbol timing correlator that became famous for its simplicity and effectiveness.

While the bursty nature of the IEEE 802.11 and IEEE 802.16 waveforms allow a time domain preamble and a trivial time domain synchronizer, the continuous transmission nature of the TV signal resulted in all of the currently deployed broadcast TV signals (most notably the European DVB-T and the Japanese ISDB-T), not having a time domain preamble. As a consequence the van de Beek synchronizer gained popularity and is employed in OFDM receiver chips for broadcast TV. The main application of the synchronizer is to acquire coarse timing to enable approximately symbol synchronous FFT operation. After symbol synchronous operation is achieved, symbol timing tuning and refinement is achieved using Scattered Pilots embedded in the frequency domain representation of the OFDM waveform. The time synchronization accuracy required by an OFDM waveform for proper demodulation is significantly lower than the accuracy required for ranging measurements.

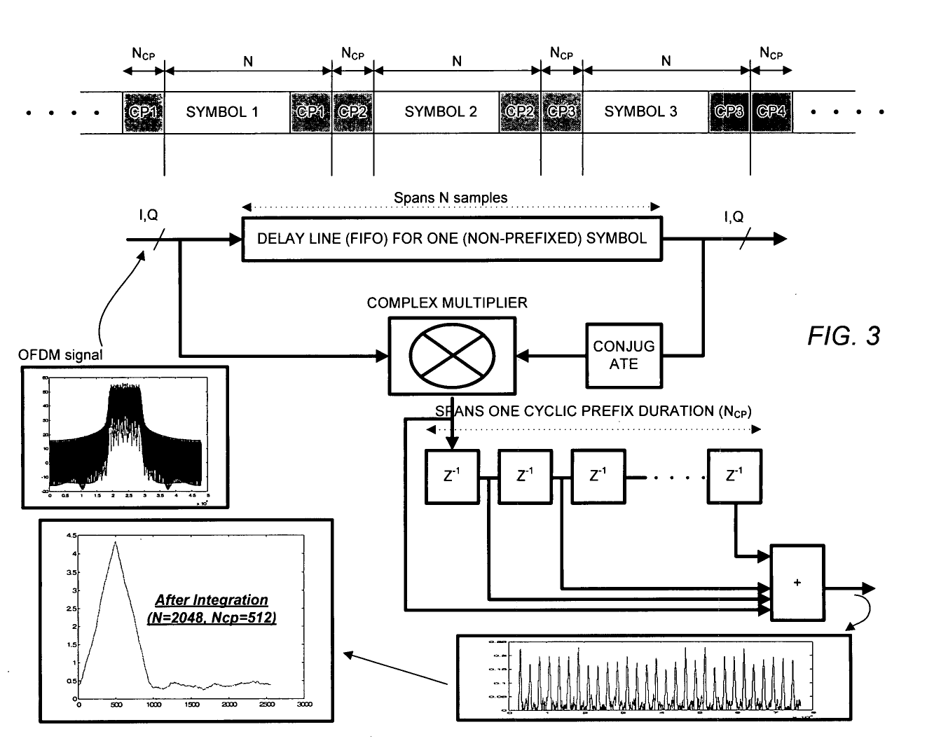

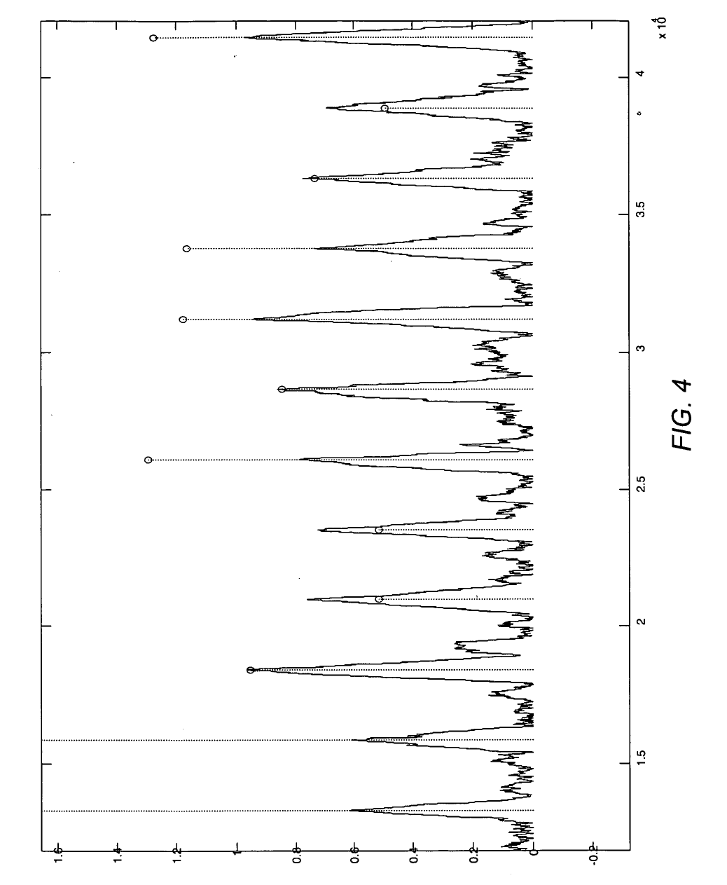

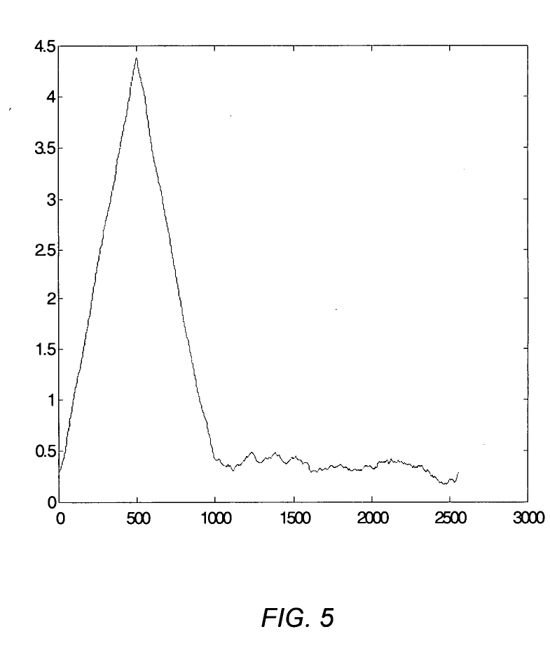

The synchronizer known to those skilled in the art of OFDM demodulation performs the following operation
c(t)=∫_{t-T}_{_{CP}}r(τ)r*(τ+T)dτ (8)

where r(t) is the baseband equivalent of the coded OFDM signal, T is the duration of the non-prefixed OFDM symbol, T_{CP} is the duration of the cyclic prefix, and c(t) is the output of the correlator, which will peak at the symbol boundary only in absence of multipath. FIG. 3 shows an implementation of the correlator. FIG. 4 shows the typical output of the correlator in response to an ISDB-T Coded OFDM signal (Mode 1, 1405 subcarriers, 2K FFT). The dotted lines identify the start of an OFDM symbol. FIG. 5 shows the Van de Beek synchronizer output for an ISDB-T Coded OFDM signal after symbol-synchronous integration of about 30 symbols.

Applying this estimator to a system with a dispersive channel results in an error floor in the time and frequency offset estimation. The error floor stems from the estimator being biased in this environment. In the dispersive channel environment the channel will introduce dependency between the samples, and the simple correlation structure of the received signal used in the AWGN model is not valid.

In fact it is trivial to prove that the well-known correlator is not the maximum likelihood time delay estimator whenever the minimum amount of multipath distortion afflicts the Radio Frequency link.

Correlator

The main problem with the Van de Beek synchronizer is that one can not extract an accurate ranging in practical situations. That scheme computes the ZERO-LAG correlation point for all possible timing combinations in one OFDM symbol. In essence it is an energy detector (for a stochastic unknown waveform) whose only known feature is its periodicity. The Van de Beek correlator is simply the maximum likelihood estimator of the symbol timing in complete absence of multipath and not the maximum likelihood estimator for ToA with realistic multipath distortion. This observation is new and has never been made.

If one wants to compute the ToA for all possible timing combinations and for all the possible lags, the scheme is much more complicated, because it involves the implementation of a “time-varying matched filter”. That is a matched filter that changes its reference waveform as time evolves. This is a two-dimensional search for timing and ToA. Mathematically this can be expressed as
c(t,θ)=∫_{t-T}_{_{CP}}r(τ)r*(τ+T−θ)dτ T≦θ≦T. (9)

This means that one should find at the same time the position of the cyclic prefix AND the delay of the waveform. This means an O[T²] complexity per sample, which is most likely unfeasible using current technology.

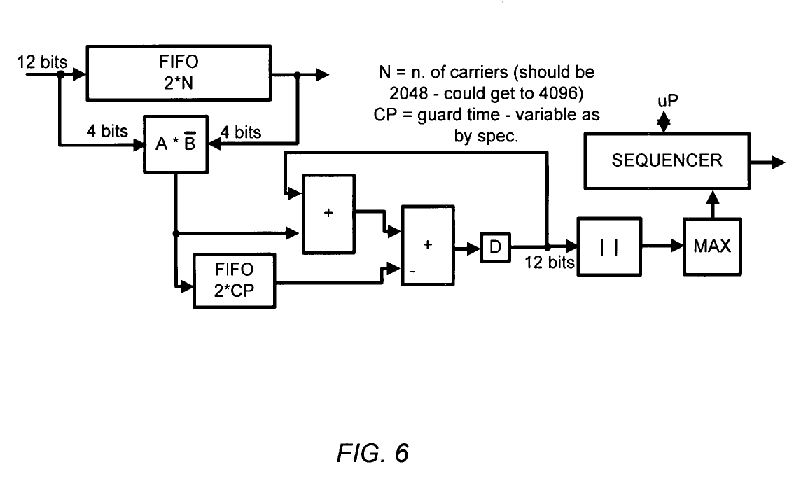

Embodiments of the present invention break down the task of symbol timing and ToA recovery. Once the symbol boundaries are known, a matched filter is loaded with the reference signal captured from the time-domain waveform itself. The symbol boundaries can be found using the scheme in FIG. 6.

The correlation operation complexity, once the symbol timing is obtained, becomes the complexity of a matched filter with length equal to the cyclic prefix. After the high accuracy matched-filtering operation is implemented on a symbol by symbol basis, coherent integration can be achieved if clock drift effects are taken into account. It is in fact important to consider the clock drift effects not only of the broadcast TV station, but also of the device that is performing the measurement (the “user device”). The estimation of the clock offset in the TV transmitter is performed using a reference station connected to the ranging network which is equipped with a very stable clock source.

The user device is however equipped with a low cost and low stability clock source. A very simple search can be performed using a time-frequency acquisition procedure similar to what is typically done in GPS receivers. Once the user clock offset is determined coherent integration can be achieved and substantial improvement is obtained in weak signal environments.

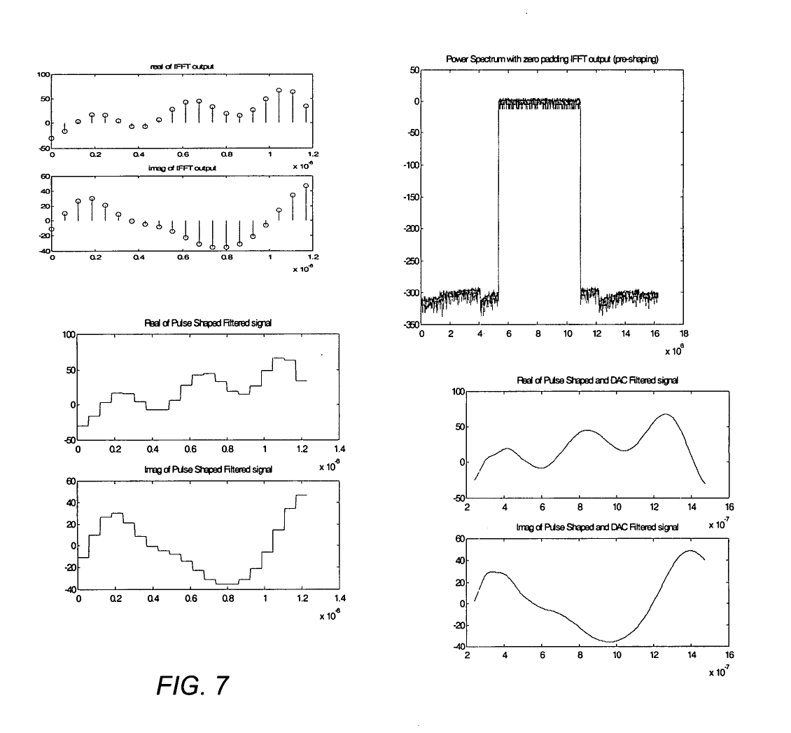

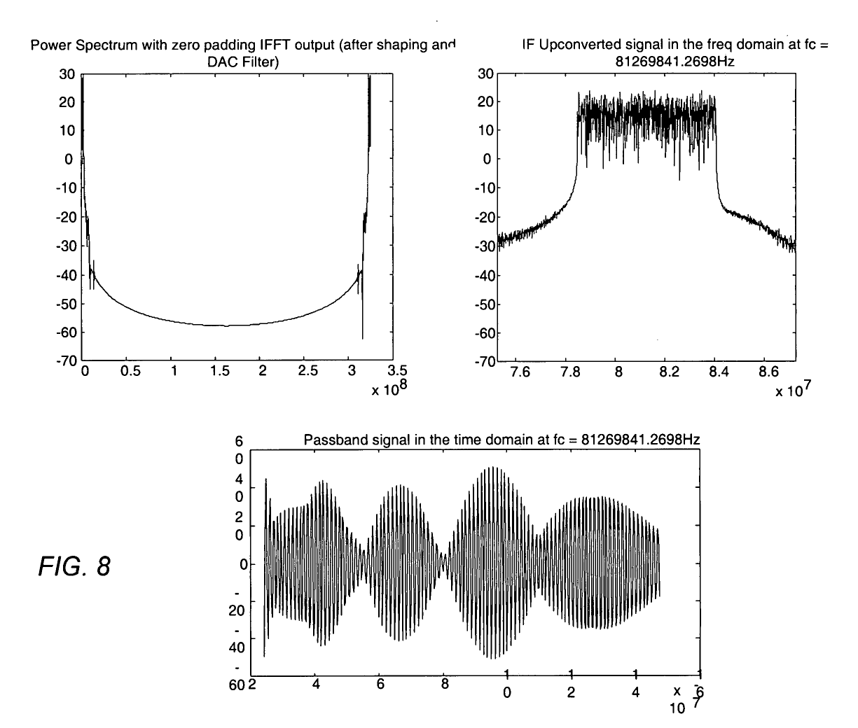

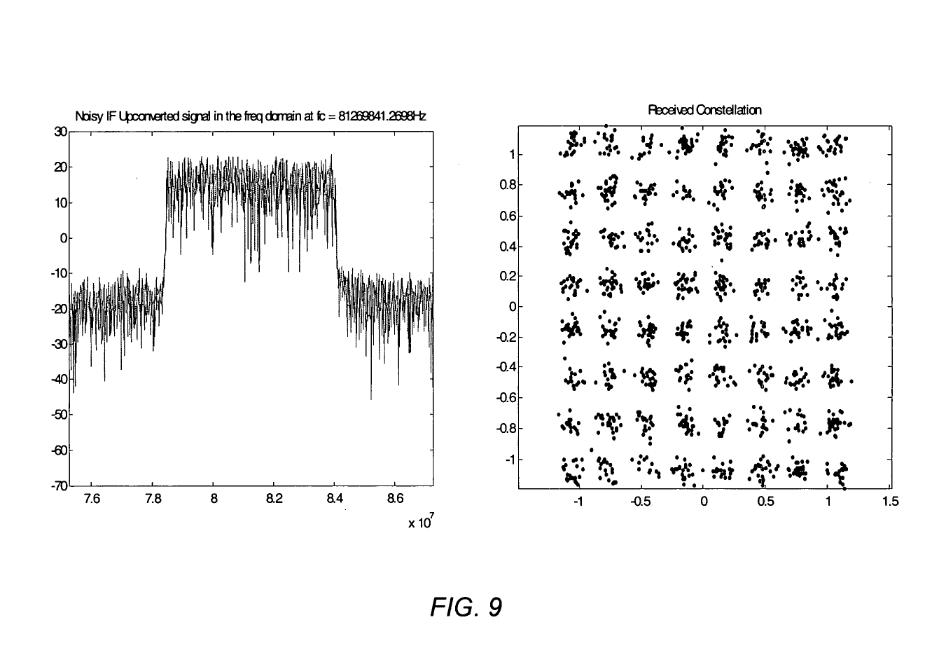

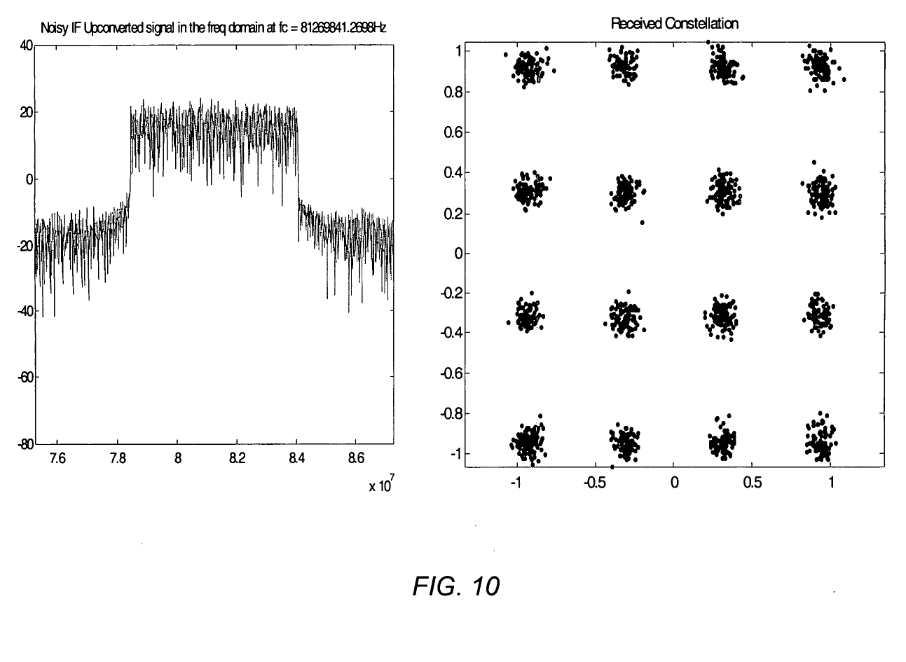

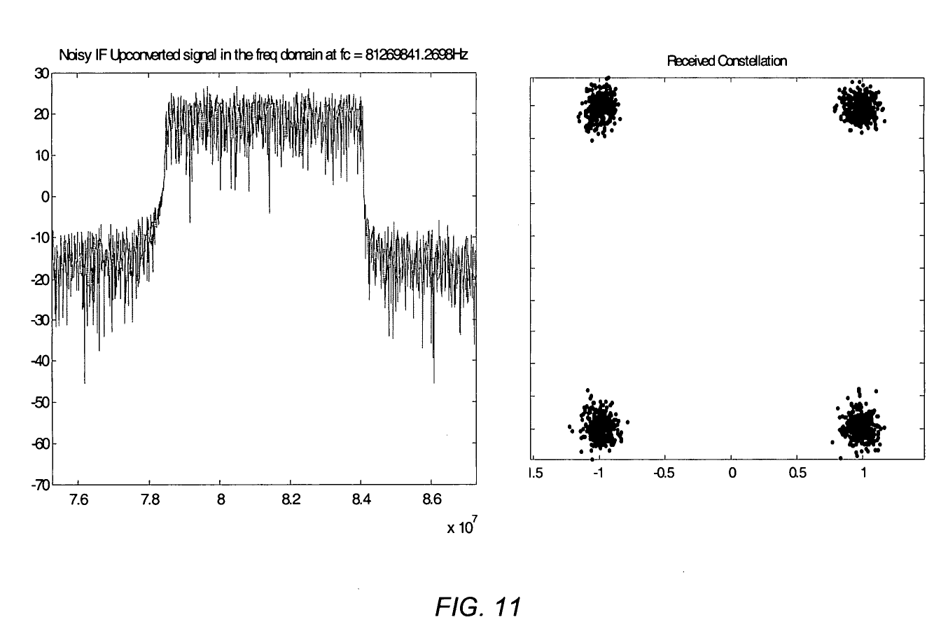

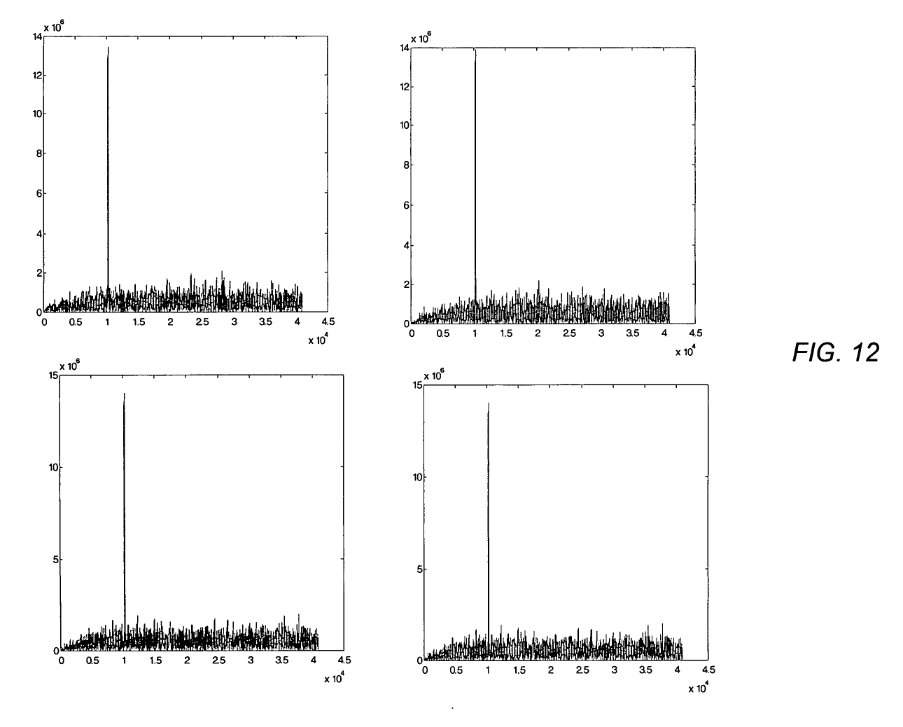

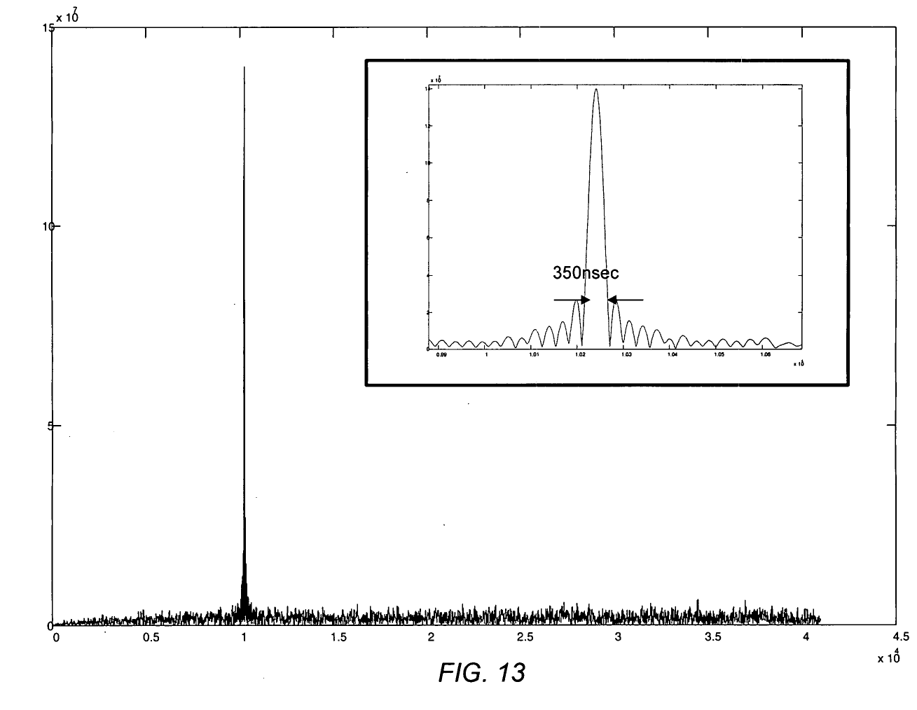

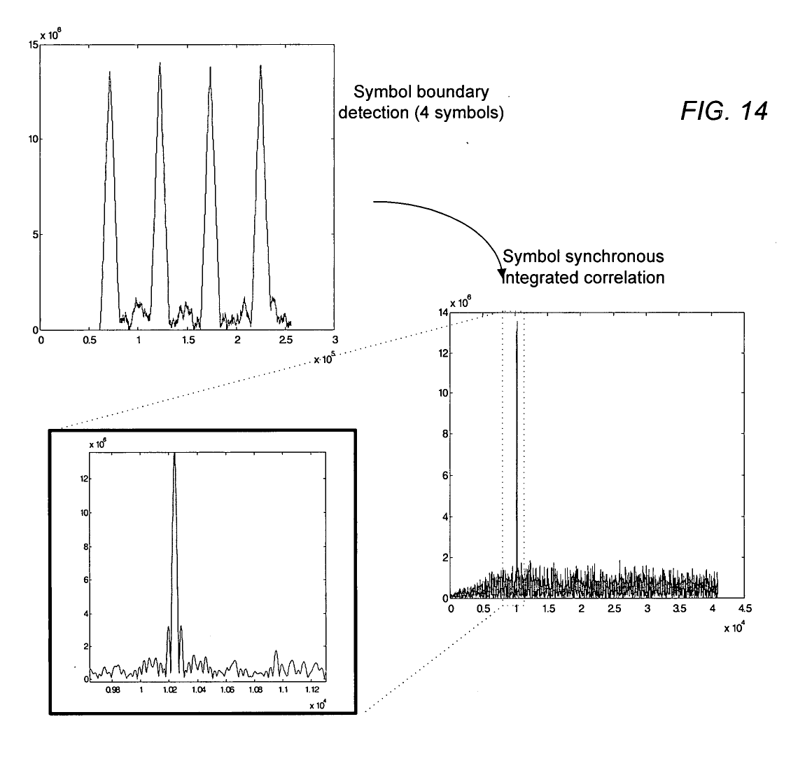

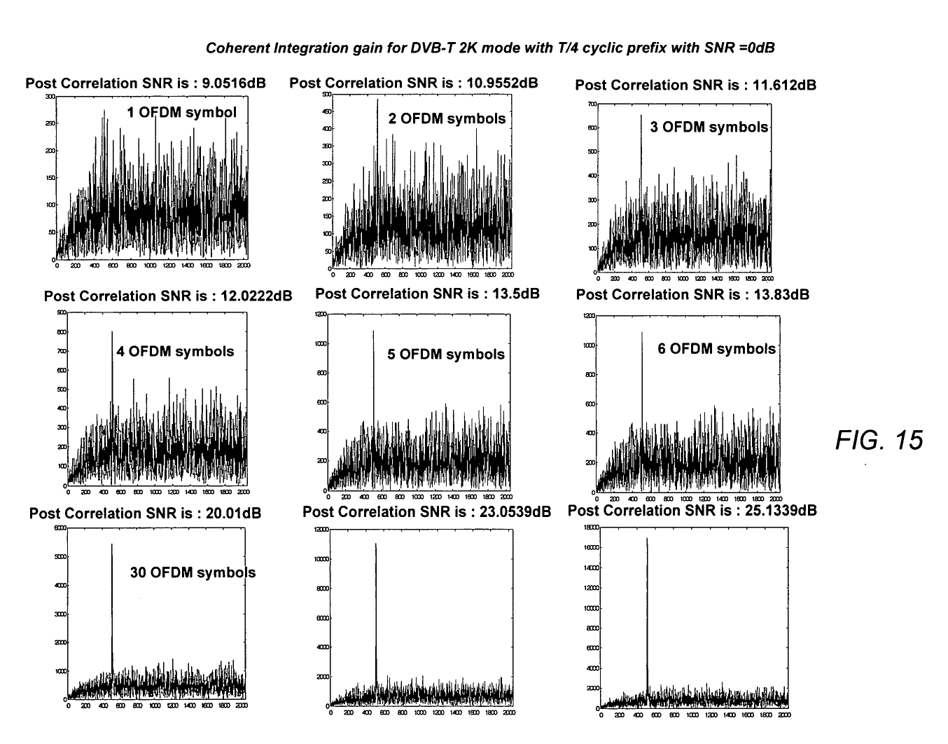

A particular example of interest is the Band-Segmented OFDM ISDB-T waveform with Mode 1. FIG. 7 shows simulation results for an ISDB-T 6 MHz waveform for Mode 1. The OFDM symbol period is 252 microseconds. The number of carriers is 1404 plus one. There are 13 segments of approximately 430 kHz each. It is assumed that there are 8 differential segments and 5 coherent segments with 64-QAM modulation on the subcarriers. FIG. 8 shows simulation results for the OFDM signal at an intermediate frequency of about 90 MHz. FIG. 9 shows an FFT-based demodulation of one of the coherent 64-QAM segments. FIG. 10 shows an FFT-based demodulation where the five segments have 16-QAM. FIG. 11 shows an FFT-based demodulation where the five segments have coherent QPSK. FIG. 12 shows examples of one-symbol envelope of the correlator outputs. FIG. 13 shows examples of five-symbol envelope of the correlator outputs with coherent integration of five symbols. The correlation shape shown in FIGS. 12-13 is clearly related to the properties of OFDM. FIG. 14 shows an example at low SNR (approximately 5 dB) with 2K FFT for Mode 1 ISDB-T where the Cyclic Prefix is ¼.

An OFDM system with large number of carriers is very close to a bandlimited Gaussian process with the net result that for ranging purposes OFDM is an “almost” optimal waveform. Since the cyclic prefix itself changes from symbol to symbol the novel correlation method gains a spectacularly random pseudonoise sequence with excellent correlation properties.

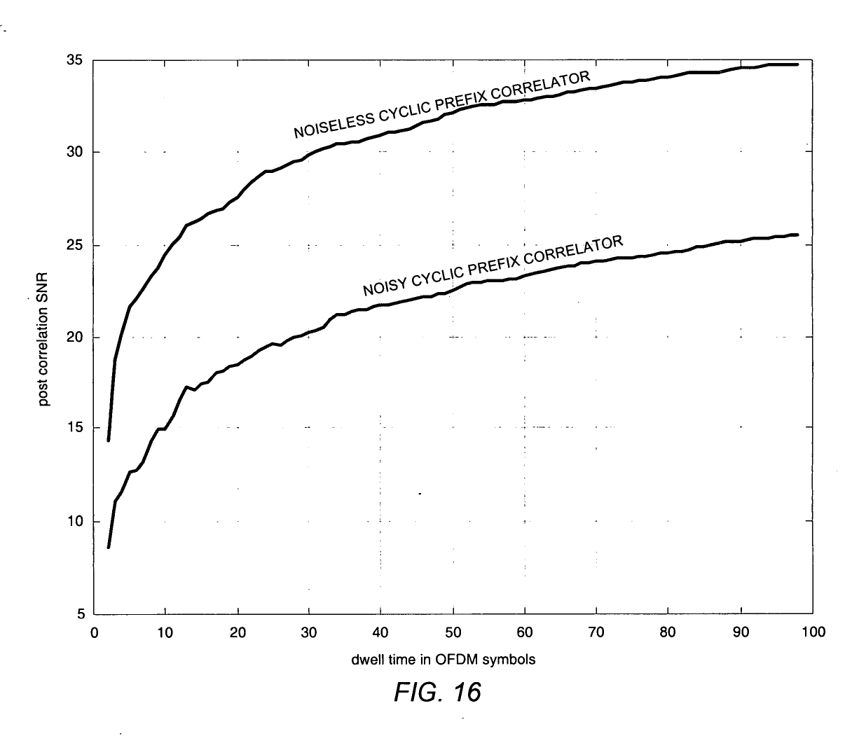

Such an unusual correlator should achieve integration gain. The output envelope of the novel self-correlator as more and more OFDM symbols are coherently integrated is shown in FIG. 15. FIG. 16 shows the integration SNR loss caused by the noise x noise effect.

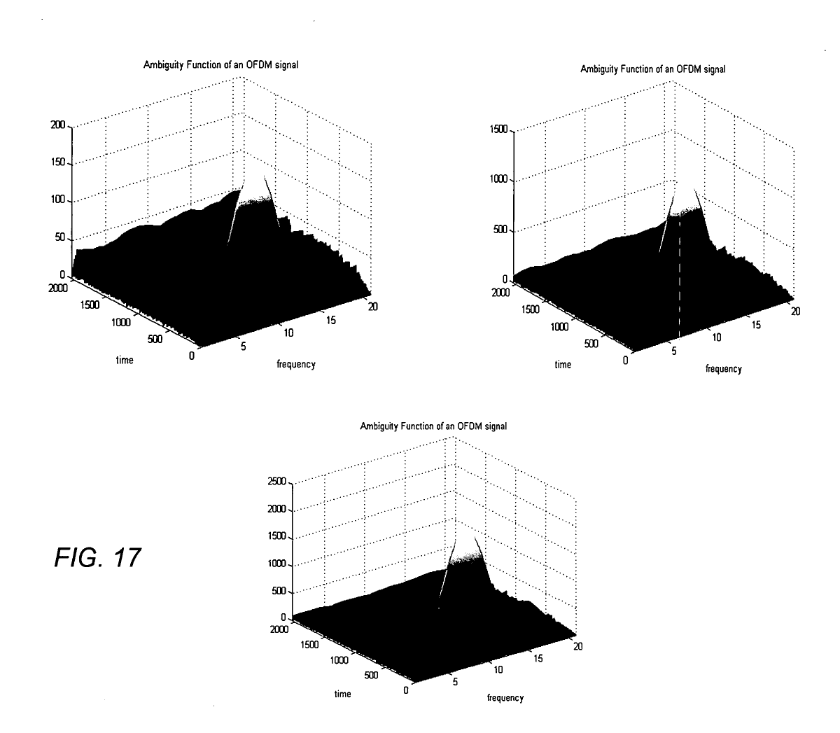

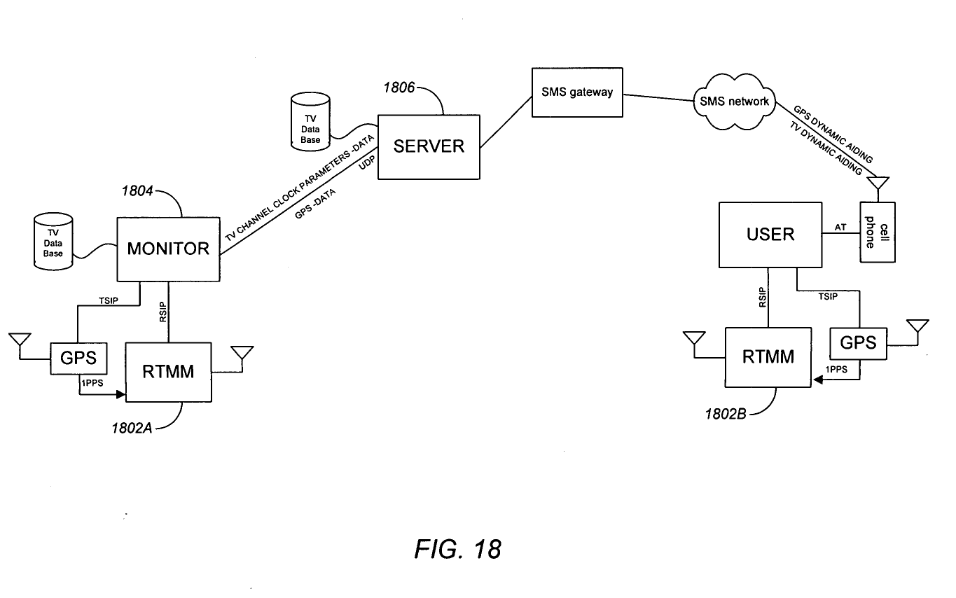

FIG. 17 shows the behavior of the ambiguity function of the T/4 cyclically prefixed OFDM signal. There is significant integration gain to be had even if the reference waveform is noisy, but of course that gain is not as large as the gain that one would have if the cyclic prefix was perfectly known. Of course a system where the cyclic prefix is perfectly known is impossible. The cyclic prefix will always be noisy, because extracted from the received signal itself. The post correlation SNR increases not only because of the traditional reason (because the matching waveform is fixed and the noise random), but also because of the randomness of the reference waveform. In OFDM correlators according to the present invention, the matching waveform is random and so the correlation waveform also averages with itself.

Ranging

The main elements of the ranging system are illustrated in FIG. 18. RTMM 1802 is the Ranging Television Measurement Module. Monitor stations 1804 continuously perform measurements of the TV channels pertinent to the geographical area of interest. The information that is transmitted at a server 1806 can be coarsely classified as Health of the TV channel, with associated set of parameters, Stability characterization of the main clocks associated with the TV channel, with associated prediction parameters, Accurate frequency measurements of carrier, and Timing information related to the times of transmissions of the synchronization codes as measured within the GPS reference.

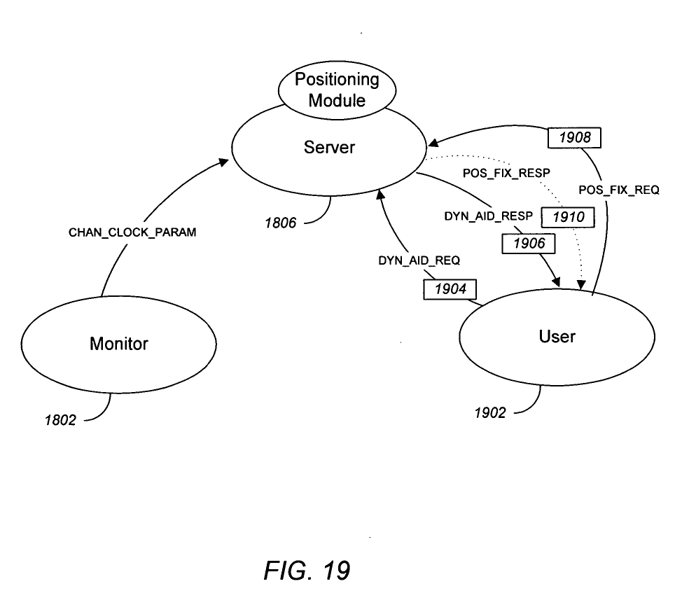

FIG. 19 shows data flows in the ranging system. User device 1902 generates a Dynamic Aid Request 1904, which is satisfied by a Server Dynamic Aid Response 1906. Dynamic Aid Response message 1906 contains the most recent Monitor measurement for the geographical area of interest. User device 1902 replies with a Position Fix Request message 1908. Position Fix Response message 1910 contains timing measurements that will allow the positioning algorithm to assemble pseudoranges much like a GPS receiver does.

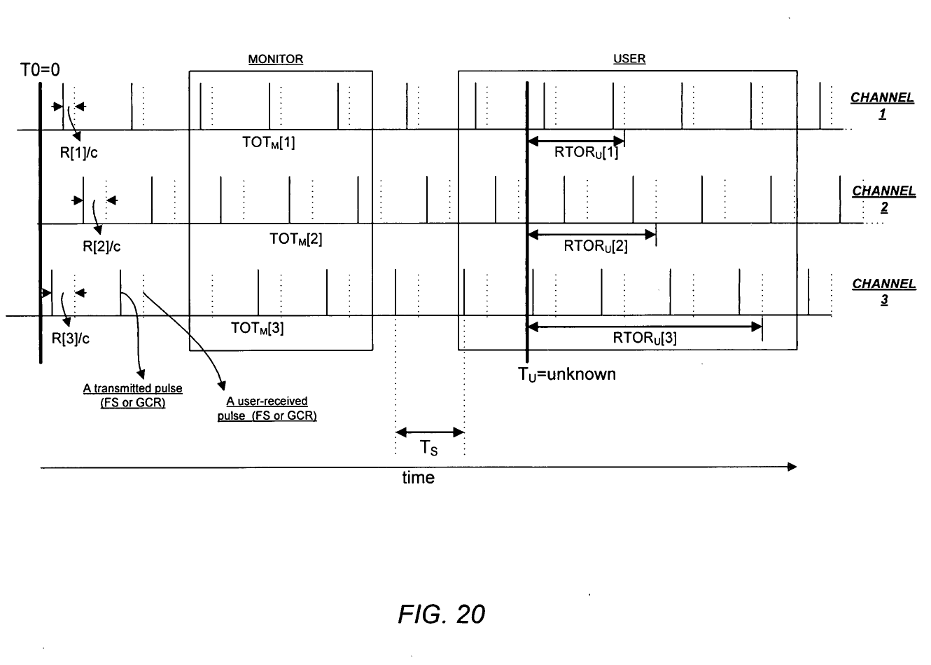

Assume availability of M TV channels (a mix of ATSC or NTSC channels in North America, ISDB-T in Japan, or DVB-T in Europe), denote c as the speed of light in meters per second and consider the timing diagram of FIG. 20. The time tags obtained in the User device are denoted RTOR_{U}[i] (i.e., RTOR_{U}[i] is the Relative Time of Reception as measured by the RTMM correlator transmitted by the ith channel at the User with respect to an unknown start time of sampling T_{U}). The time tags obtained by the Monitor (equipped with a GPS receiver) are defined TOT_{M}[i]. TOT_{M}[i] is the absolute Time of Transmission of a generic Field Synchronization sequence or GCR (Ghost Canceling reference) or cyclic prefix as transmitted by the ith channel and estimated by the Monitor. Observe that TOT_{M}[i] can be obtained at the Monitor, using the knowledge of the Monitor coordinates and GPS time. R_{U}[i] is the true range User to ith TV channel (coming from a generic TV transmitter at coordinates Xᵢ, Yᵢ, Zᵢ, and related to the user coordinates (X,Y,Z) as
R_{U}[i]=\sqrt{(X−Xᵢ)²+(Y−Yᵢ)²+(Z−Zᵢ)²}.

The positioning algorithm for a TV-only positioning event is based on the selection of a master station for the TV channel set and the formation of difference pseudoranges. A TV pseudorange for the generic TV station is denoted
\hat{ρ}ᵢ=R_{U}[i]−R_{U}[1]+δb_{U}[i]−δB[i]+δT_{U,i}+ηᵢ,

where R_{U}[i] is user range to ith station, R_{U}[1] is user range to station 1, the master station, δb_{U}[i] is the difference in the user receiver clock error between the times at which TOA measurements for channel i and for the master channel have been performed, δB[i] is the difference in the TV transmitter clock error between the times of transmission for channel i, δT_{U,i} is the difference in tropospheric delay along the Line of Sight between the two channels transmitters, and ηᵢ is the measurement error.

The ranging network of monitors can provide an estimate of the corrections necessary to remove (or significantly reduce) the errors db_{U}[i], dB[i], and dT_{U,i}. The corrected TV pseudorange is referred to as ρᵢ.

The user coordinates in a TV-only positioning event can be obtained from the equations

$${ρ}_{i} = \sqrt{{( X - {X}_{i} )}^{2} + {( Y - {Y}_{i} )}^{2} + {( Z - {Z}_{i} )}^{2}} - \sqrt{{( X - {X}_{1} )}^{2} + {( Y - {Y}_{1} )}^{2} + {( Z - {Z}_{1} )}^{2}}$$

$$i = 2 , … , M .$$

The GPS pseudoranges result in the following equations
\hat{ρ}_{GPS,i}=R_{U,GPS}[i]+b_{GPS}−B_{i,GPS}+Iᵢ+Eᵢ i=1, 2, . . . , M_{GPS}, (10)

where b_{GPS} is GPS receiver clock offset from GPS time, B_{i,GPS} is GPS transmitter clock offset from GPS time, Iᵢ is ionospheric error, and Eᵢ is tropospheric error.

The ranging network of monitors can provide an estimate of the corrections necessary to remove (or significantly reduce) the errors B_{i,GPS}, Iᵢ, and Eᵢ. The corrected GPS pseudorange is referred to as ρᵢ.

The user coordinates in a GPS-only positioning event involving N satellites can be obtained from the equations
ρ_{GPS,i}=\sqrt{(X−X_{GPS,i})²+(Y−Y_{GPS,i})²+(Z−Z_{GPS,i})²}+b_{GPS}, i=1, . . . , N. (11)

The simplest method to solve for position using a mix of TV/GPS ranging measurements is to collapse the two sets of equations exploiting the fact that the TV pseudorange differences cases are substantially “time-independent”. The linearized equations are

$$[ \begin{matrix}{Δρ}_{TV} \\ {Δρ}_{GPS}\end{matrix} ] = [ \begin{matrix}{A}_{TV} & 0 \\ {A}_{GPS} & 1\end{matrix} ] Δ x ,$$

where Δx=[ΔX, ΔY, Δb_{GPS}]^{T} are perturbations in X, Y, b_{GPS} while Δρ_{TV} and Δρ_{GPS} are the corresponding pseudorange perturbations for TV and GPS. The ith row of A_{TV} has two elements

$$\frac{X - {X}_{i}}{\sqrt{{( X - {X}_{i} )}^{2} + {( Y - {Y}_{i} )}^{2}}} - \frac{X - {X}_{1}}{\sqrt{{( X - {X}_{1} )}^{2} + {( Y - {Y}_{1} )}^{2}}}$$

$$and$$

$$\frac{Y - {Y}_{i}}{\sqrt{{( X - {X}_{i} )}^{2} + {( Y - {Y}_{i} )}^{2}}} - \frac{Y - {Y}_{1}}{\sqrt{{( X - {X}_{1} )}^{2} + {( Y - {Y}_{1} )}^{2}}} .$$

The ith row of A_{GPS} has two elements

$$\frac{X - {X}_{i , GPS}}{\sqrt{{( X - {X}_{i , GPS} )}^{2} + {( Y - {Y}_{i , GPS} )}^{2} + {( Z - {Z}_{i , GPS} )}^{2}}}$$

$$and$$

$$\frac{Y - {Y}_{i , GPS}}{\sqrt{{( X - {X}_{i , GPS} )}^{2} + {( Y - {Y}_{i , GPS} )}^{2} + {( Z - {Z}_{i , GPS} )}^{2}}} .$$

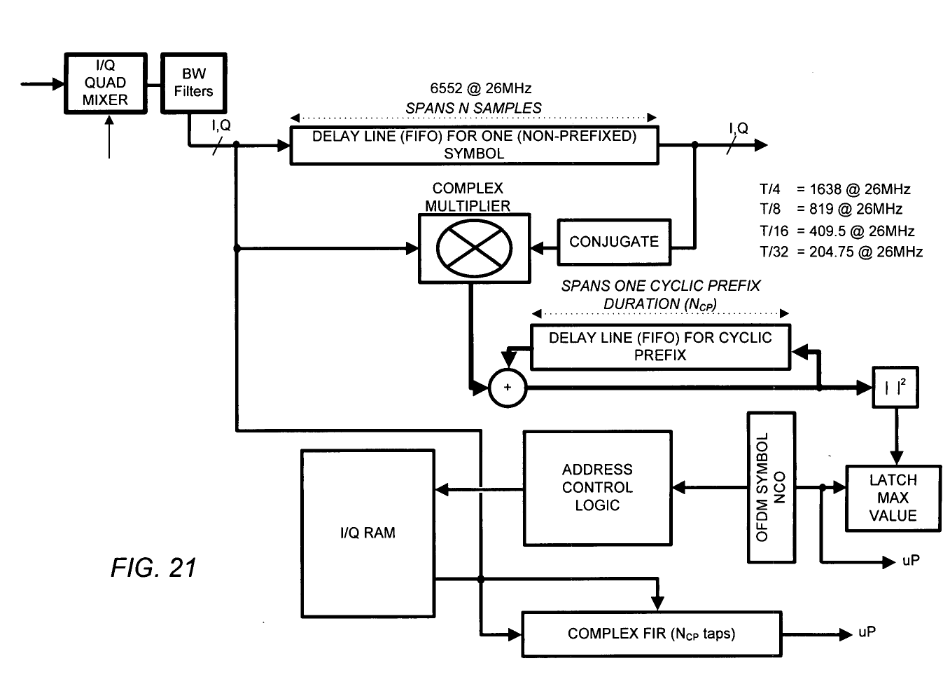

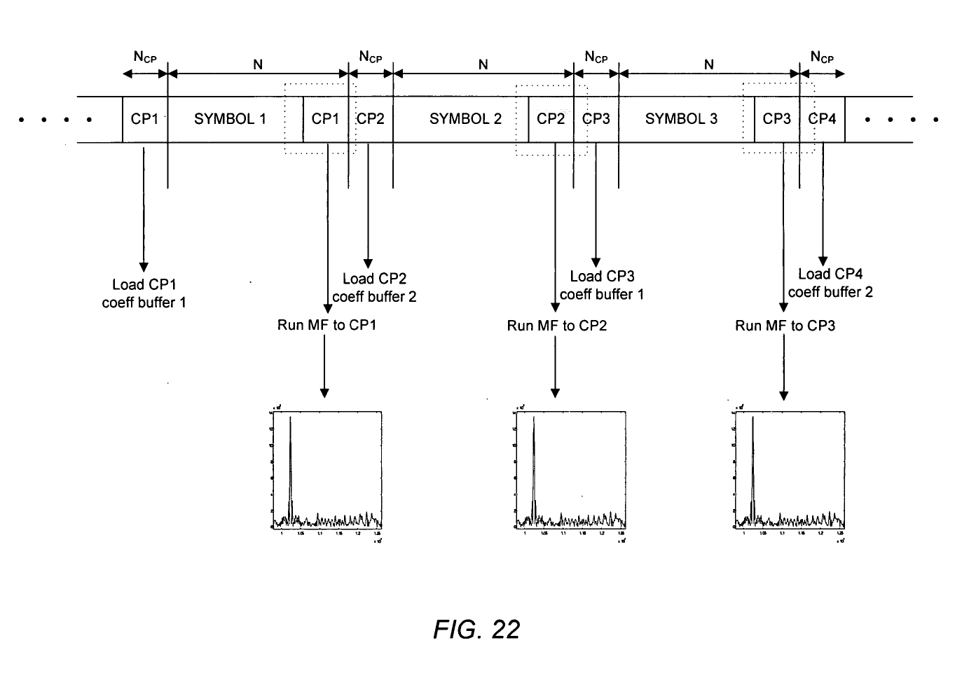

FIG. 21 shows a functional block diagram of a correlator based on a two-buffer approach according to a preferred embodiment of the present invention. The first buffer loads the initial part of the OFDM symbol, while the second buffer is holding the taps of the matched filter. FIG. 22 shows a high-level timing diagram for the correlator of FIG. 21.

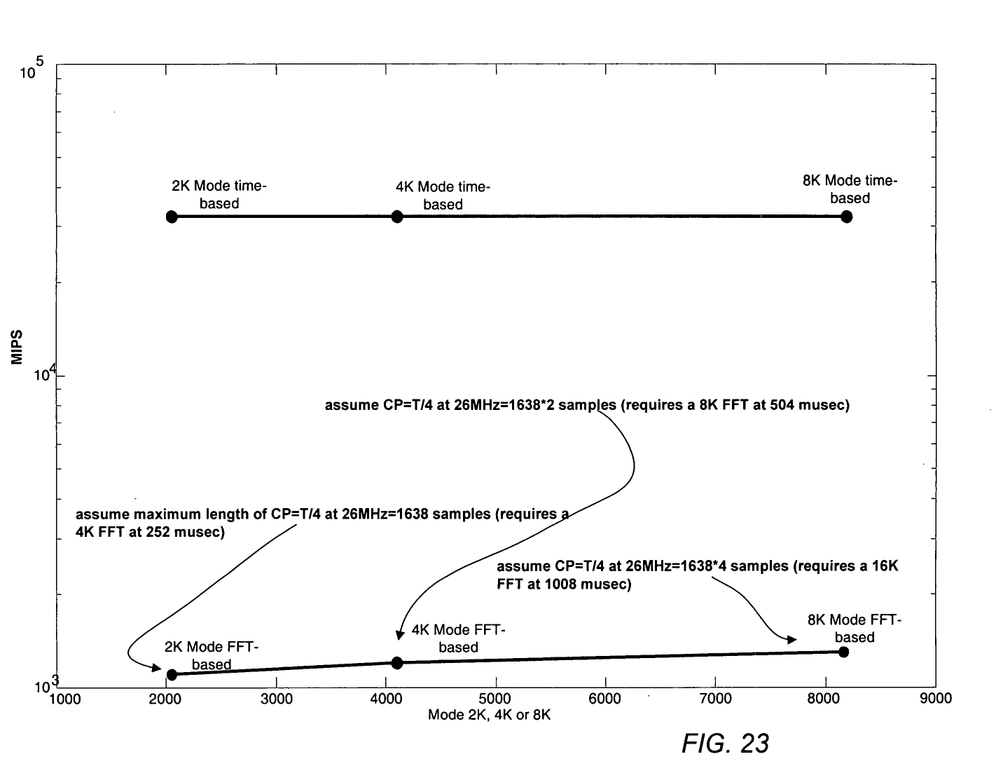

Now the feasibility of matched filter with thousands of complex taps is discussed. FIG. 23 shows the computational complexity of this “self-matched” filter in the time domain and in the frequency domain, with emphasis on the computational advantage of a frequency domain convolution approach. Until the development of the FFT convolution by frequency domain multiplication was impractical. The FFT algorithm reduces the number of mathematical operations for computation of a discrete Fourier transform (DFT) from N² to Nlog₂N. Performing a convolution function consists of transforming to the spectral domain, multiplication of the two functions and finally, an inverse transformation.

As shown in FIG. 23, the implementation of the self-matched filter in the frequency domain is dramatically advantageous for all modes of operation of ISDB-T and DVB-T with respect to a traditional time domain filter. In fact the feasibility of a time domain approach is questionable.

An objective of a matched filter processor is to obtain a continuous convolution of the input signal with a replica of the transmitted time function. This is referred to as an “all range” matched filter. However, multiplying the discrete Fourier coefficients corresponds to convolving two periodic waveforms in the time domain; thus, the amount of useful data which can be obtained is limited. If, for example, an N-point waveform reference is convolved with N signal sample points, only the zero delay point in the convolution is valid since all the delayed convolution points are constructed from samples in the replica reference and signal functions. If the N-point waveform reference signal is situated in an aperture of length 2N, the number of valid points in the convolution is increased to N. This is the minimum aperture length for a continuous convolution with an N-point waveform reference.

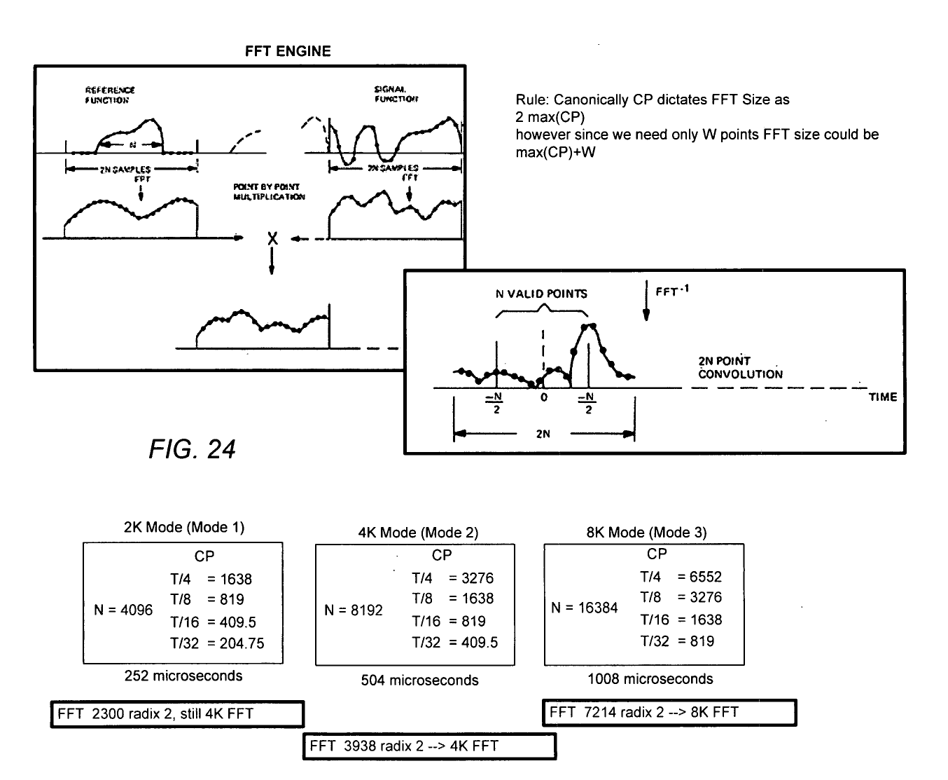

FIG. 24 shows the conceptual operation of a frequency domain filter according to a preferred embodiment of the present invention. Also shown are the parameters of a system that samples an Intermediate Frequency at 26 MHz. These parameters apply to a particular embodiment for DVB-T and ISDB-T. The 2K mode of DVB-T corresponds to Mode 1 of ISDB-T, the 4K-mode of DVB-T corresponds to Mode 2 of ISDB-T and the 8K mode of DVB-T corresponds to ISDB-T Mode 3.

As described above, the length of the matched filter is driven by the duration of the Cyclic Prefix. One embodiment involves sampling the 44 MHz Intermediate Frequency of a typical TV tuner chip. A convenient sampling rate is 26 MHz. The bottom part of FIG. 24 lists the FFT size required for DVB-T and ISDB-T for the different protocol parameters.

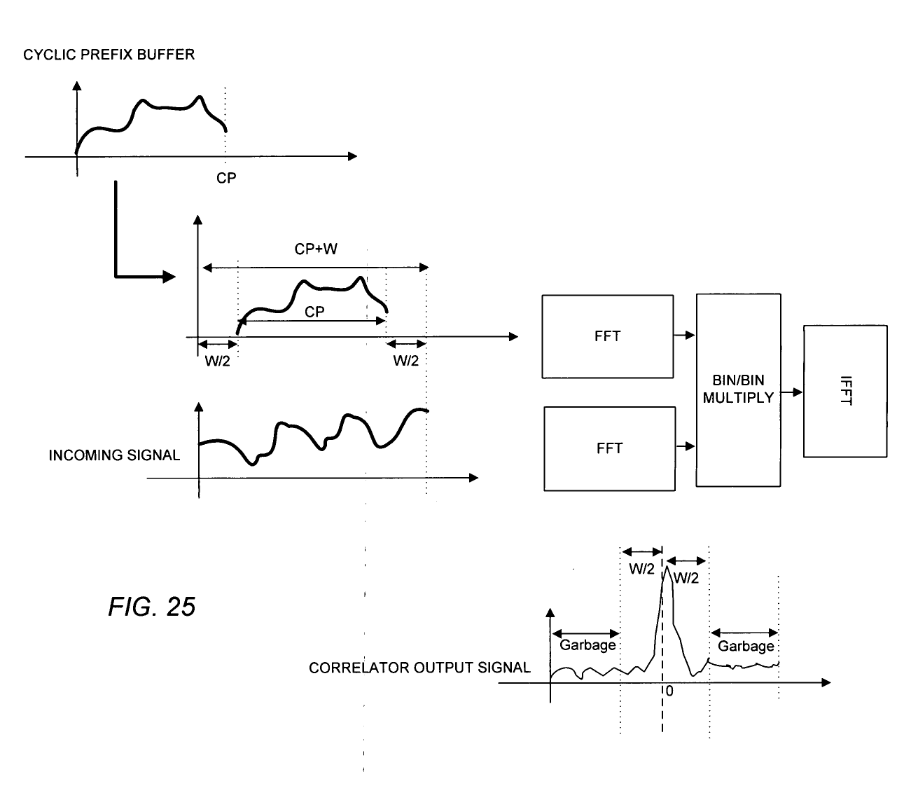

A simplification results from the fact that the aperture needed in the FFT is much less than the FFT size. The size of the aperture (or window) is identified as W. From experimental results, W=666 with a sampling rate of 26 MHz is preferred. FIG. 25 shows a schematic summary of the frequency domain matched filter operation. The window size W must be large enough to capture the largest expected delay spread on the multipath channel.

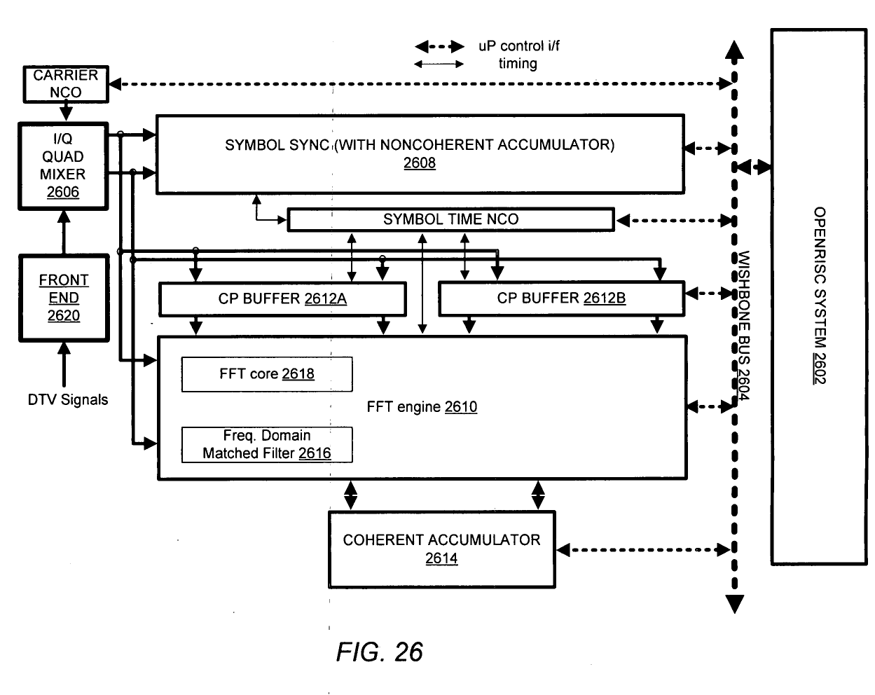

FIG. 26 shows a single-chip ASIC architecture of a correlator according to a preferred embodiment of the present invention. The chip contains in a single package all of the logic necessary to process all modes of DVB-T and ISB-T. A RISC processor 2602 interfaces through the standardized Wishbone bus to the correlator logic. A front end 2620, which is preferably not located on the chip, receives the DTV signals. A I/Q quadrature mixer 2606 contains a well-known processing element for baseband translation under control of the frequency tuning register directly accessed by RISC processor 2602. A Symbol Synchronizer 2608 performs coarse estimation of the OFDM symbol boundaries. A FFT engine 2610 and two cyclic prefix buffers 2612 implement the self-referenced matched filter.

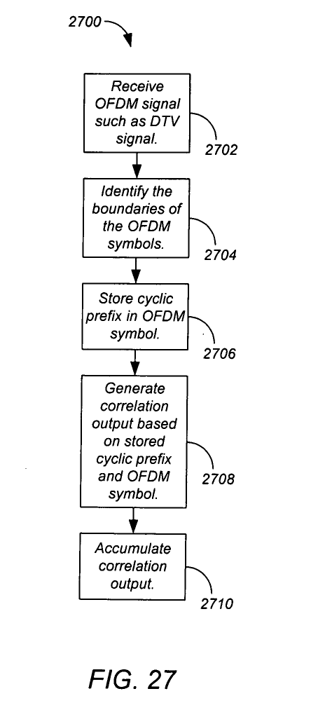

FIG. 27 shows a process 2700 for the correlator of FIG. 26 according to a preferred embodiment. Front end 2620 receives an OFDM signal such as a DTV signal comprising a plurality of OFDM symbols each comprising N samples and a cyclic prefix comprising M of the N samples, wherein M<N (step 2702). The OFDM signal can be a European Telecommunications Standards Institute (ETSI) Digital Video Broadcasting-Terrestrial (DVB-T) signal; a ETSI Digital Video Broadcasting-Handheld (DVB-H) signal; a Japanese Integrated Services Digital Broadcasting-Terrestrial (ISDB-T) signal, or any similar signal.

Synchronizer 2608 identifies the boundaries of the OFDM symbols (step 2704). One of buffers 2612 stores the cyclic prefix for one of the OFDM symbols (step 2706). FFT engine 2610 generates a correlation output based on the stored cyclic prefix and the OFDM symbol (step 2708). In particular, as described above, FFT engine 2610 generates frequency-domain representations of the OFDM symbol and the corresponding cyclic prefix, generates a product of the frequency-domain representations; and generates a time-domain representation of the product. Accumulator 2614 accumulates the correlation output for a plurality of the OFDM symbols (step 2710).

The correlation output has many uses. For example, a ranging unit can determine the location of an apparatus comprising the correlator based upon the correlation output. As another example, a demodulator can demodulate the OFDM signal based upon the correlation output.

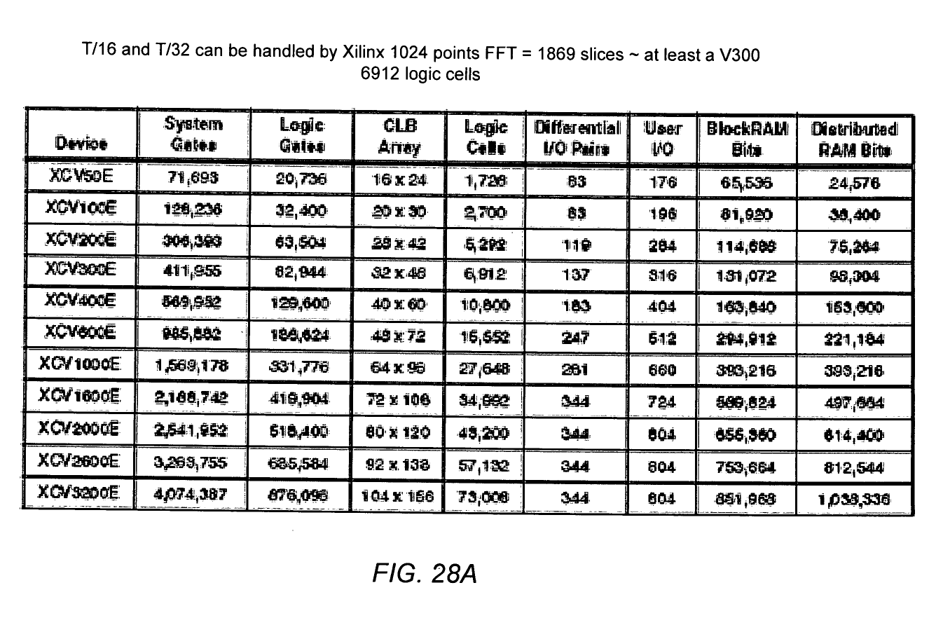

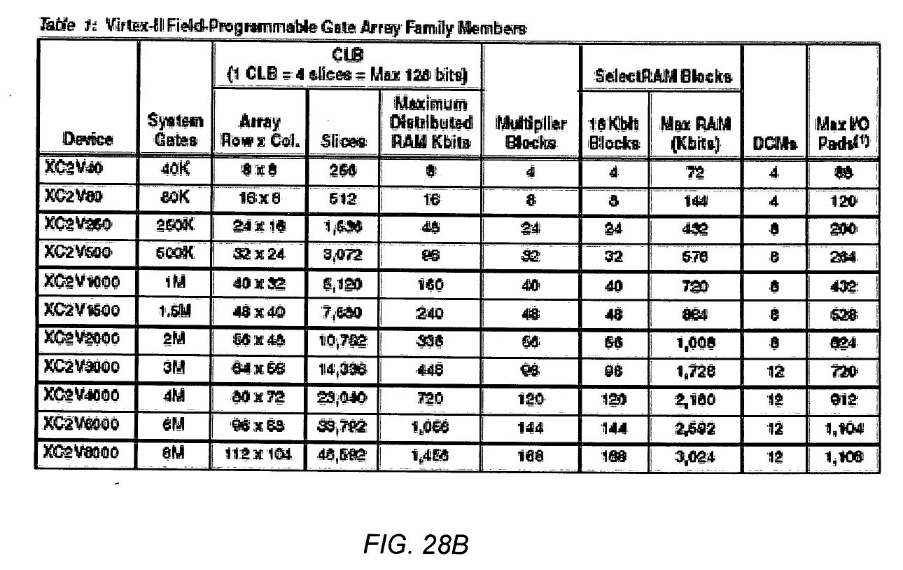

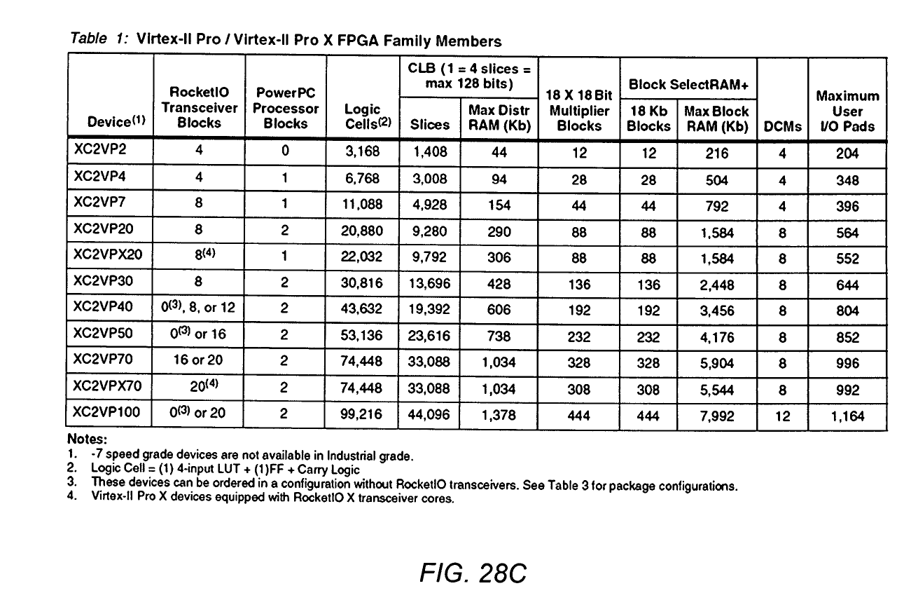

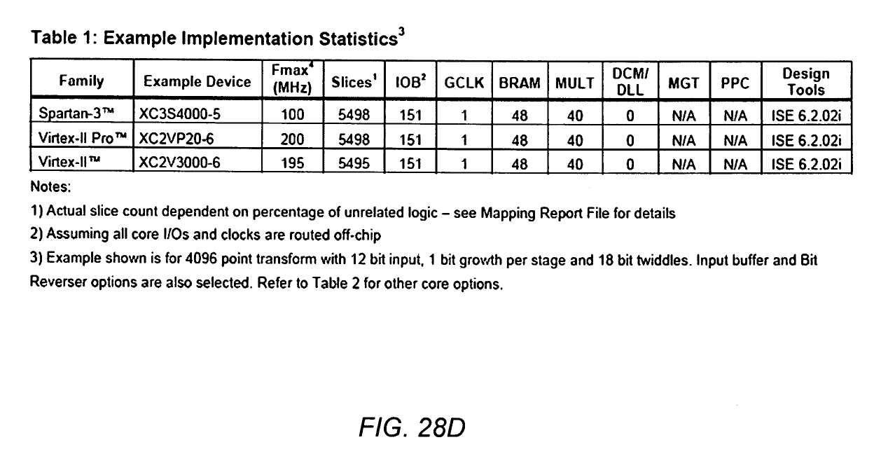

An embodiment of the device that allows a smooth transition to silicon is the implementation of the chip in a Field Programmable Gate Array (FPGA). The preferred devices are Xilinx Virtex 2 Pro. FIG. 28 shows the salient characteristics of the FPGA devices in this family. The Vitex 2 family resources include Multiplier blocks (18×18 bits) for multiply-intensive DSP functionality and RAM Blocks for memory-intensive DSP functionality. In particular the Virtex Pro contains 18 kbit blocks.

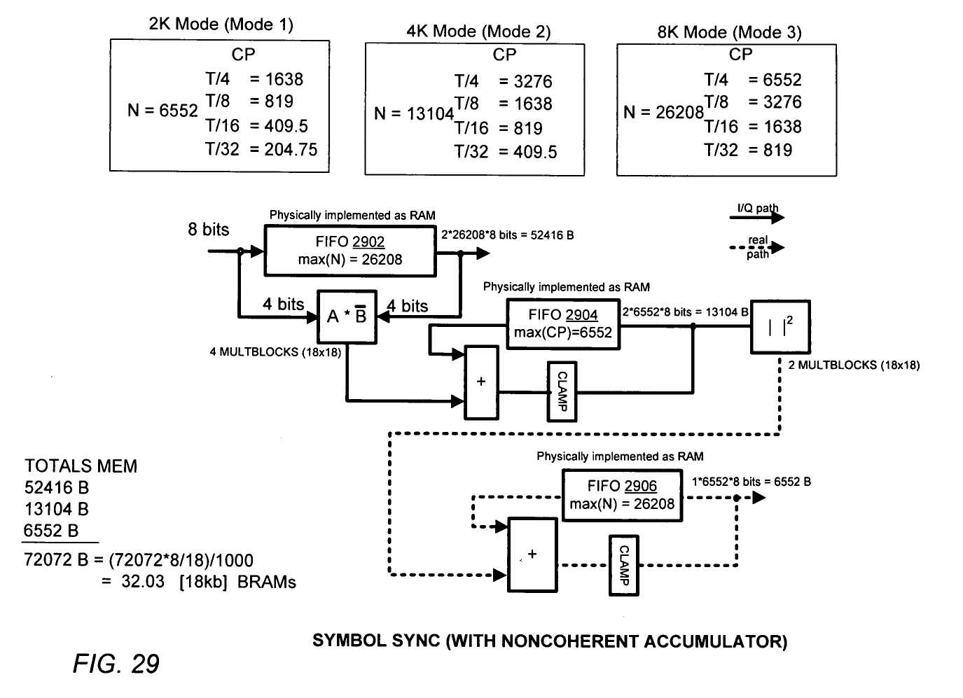

FIG. 29 shows a block diagram of symbol synchronizer 2608 according to a preferred embodiment. The size of complex FIFOs 2902 (one for I and one for Q) is set for the worst case OFDM symbol duration, for example 26208 by 8 bits. Complex FIFO 2904 implements the integrator of the single lag correlator, and is sized by the maximum duration of the cyclic prefix, 6552 by 8 bits. Single FIFO 2906 is of size 26208 by 8 bits. The total memory is preferably 52416+13104+6552 Bytes, which translates to 32.03 RAM Blocks. The multiplier for the symbol synchronizer is 6 multiplier blocks.

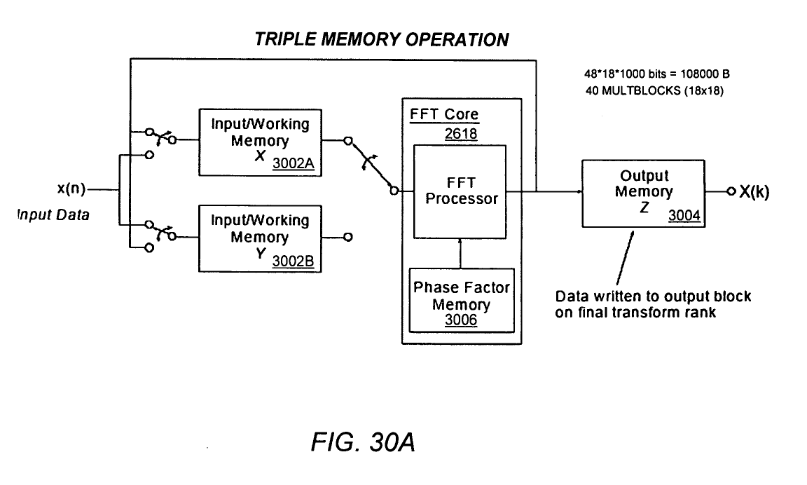

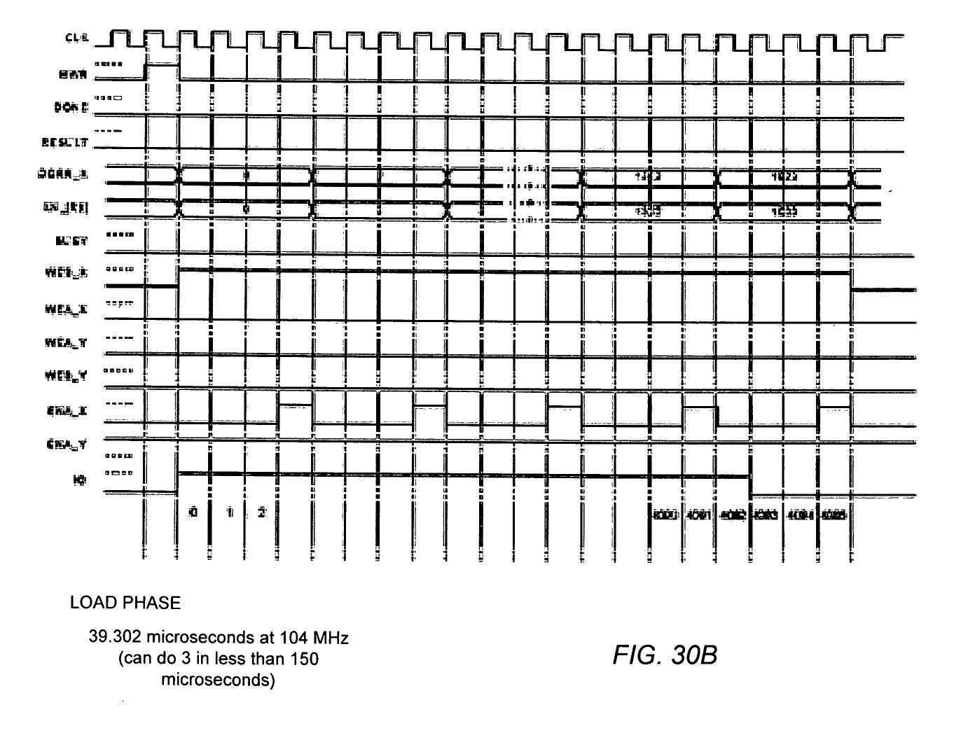

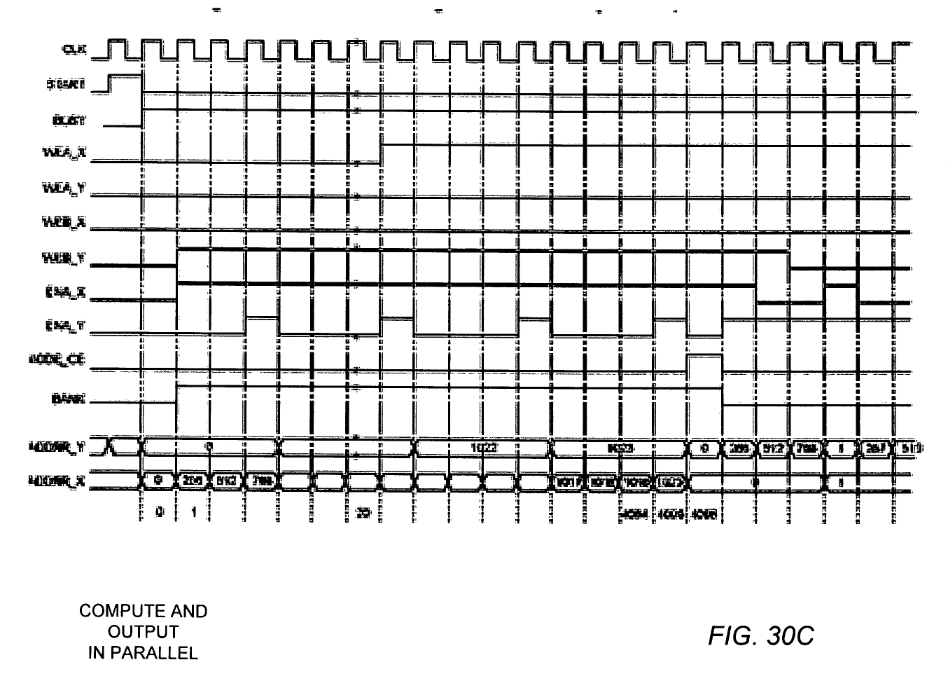

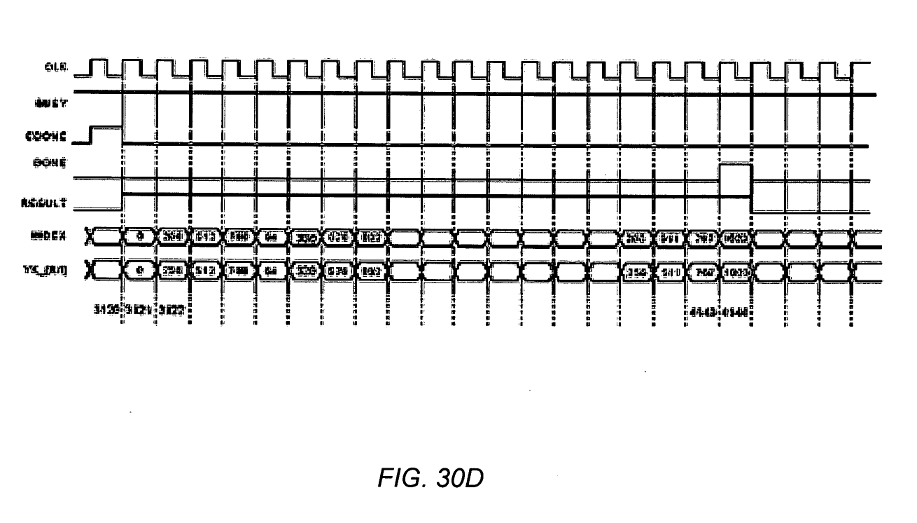

FIG. 30 shows FFT engine 2610 with triple memory operation according to a preferred embodiment. The first memory 3002 is used to buffer input samples, the second memory 3004 to buffer output samples, and the third memory 3006 as the intermediate results memory. FFT core 2618 performs a real-time N-point Discrete Fourier Transform (DFT) using a Pipelined Decimation-In-Frequency (DIF), Fast Fourier Transform (FFT) algorithm. FFT core 2618 can also provide the inverse DFT via a user controlled input. N is the number of points or size of the FFT, which is fixed on delivery. FFT core 2618 can process complex input data in continuous real-time, with no gaps in the data, at complex data rates in excess of 400 MS/s.

The architecture is based on N successive stages, where 2N is the FFT size. Each stage has switched delay elements and butterflies. The switches and delays of each stage re-order the data into the correct order for processing by the butterfly. There are N butterflies, each performing a 2-point Discrete Fourier Transform (DFT) and complex phase rotations (twiddles).

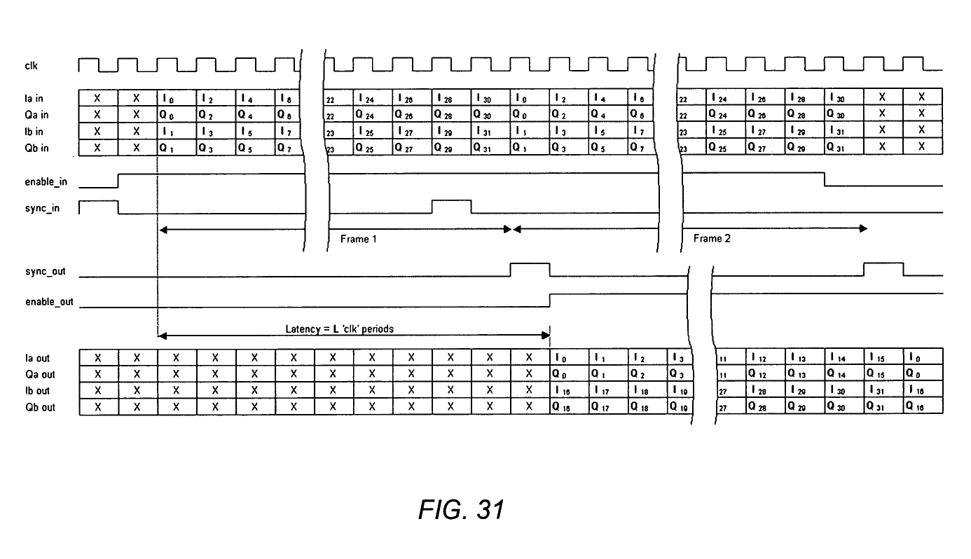

The core input/output signals are clk: Input, where the core clock rate is equal to fₛ/2, where fₛ is the complex sample rate; rst_p: Input, which is an active-high pulse of duration greater than 2 core clock periods, and which resets the FFT control logic, but not the FFT pipeline; sync_in: Input, which is an active-high pulse marking the first sample of a new input block and precedes first samples of complex input data by two clock periods; enable_in: Input, which is an active-high signal asserted for a duration equal to the FFT block length, and is asserted one clock period before the first samples of complex input data; fft_ifft: Input, which is an active-high signal to select FFT function, else an IFFT function is performed; Ia_in, Qa_in, Ib_in, Qb_in: Input, which are two's complement interleaved time-domain data; sync_out: Output, which is an active-high pulse marking the first transformed sample of a new output block, and is asserted one clock period before the first transformed samples of a new output block; enable_out: Output, which is an active-high signal asserted for duration equal to the FFT block length, and is coincident with the first transformed samples of a new output block; and Ia_out, Qa_out, Ib_out, Qb_out: Output, which are two's complement interleaved frequency-domain data. FIG. 31 shows a timing diagram for the FFT core assuming an example with N=32.

Latency can be assessed as the time from when the first complex sample of an input block is clocked into the FFT to the time when the first transformed complex frequency output sample is clocked out from the FFT. This is shown in the timing diagram example of FIG. 30. The latency in FFT core clock periods can be calculated by
L=t_{ib}+t_{fft}+tₐᵣₑₐ+t_{br}

where
t_{ib}=(N/4+3),
t_{fft}=N/2+10 log₂(N)−13,
tₐᵣₑₐ=log₂(N)−2,
t_{br}=N/2−2^{floor(log}^{₂}^{(N/2)/2)}−2^{floor((log}^{₂}^{(N/2)+1)/2)}+10, and
N is the FFT length.

The FFT core configured for the self-referenced matched filter can perform an 8K FFT in approximately 40 microseconds assuming a clocking speed of 104 MHz. The core requires 108000 Bytes of memory equivalent to 48 RAM blocks and 40 Multiplier blocks. The Hold Buffers require 2*(2*4096*16) bits or 32768 Bytes equivalent to 16 RAM blocks. The actual frequency domain filter requires 4*4096 Multiplies/50 musec=4*4096/5200 clocks (\@104 MHz)=3.1508 MACs/clk=4 Multiplier blocks.

Referring again to the overall ASIC diagram of FIG. 26, the memory/multiplier requirements can be summarized. The memory requirements are 13104 Bytes for Cyclic Prefix Buffer 2612A, 13104 Bytes for Cyclic Prefix Buffer 2612B, 2664 Bytes for coherent accumulator 2614, 72072 Bytes for symbol synchronizer 2608, and 32768 Bytes for matched filter 2616. The total memory is 241712 Bytes /(18*1000) which translates to 108 RAM blocks. The memory requirements are 40 Multiplier blocks for FFT core 2618, 4 Multiplier blocks for frequency domain matched filter 2616, and 6 Multiplier blocks for symbol synchronizer 2608. The total multiplier count is 50 18×18 multiplier blocks.

Since the requirements of symbol synchronizer 2608 and FFT matched filter 2616 are estimated to drive 90% of the complexity in the chip, the minimum size FPGA device that can support full mode (ISDB-T Mode 1, 2 and 3 as well as DVB-T 2K, 4K and 8K) is a Xilinx Virtex-II Pro XC2VP30. This device has 136 multiplier blocks, 136 RAM blocks and approximately 13,696 slices. Of course, the correlator can be implemented using other devices.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

1. An apparatus comprising:
a front end to receive an orthogonal frequency division modulation (OFDM) signal comprising a plurality of OFDM symbols each comprising N samples and a cyclic prefix comprising M of the N samples, wherein M<N;
a buffer to store the cyclic prefix for one of the OFDM symbols; and
a correlator to generate a correlation output based on the cyclic prefix and the one of the OFDM symbols.

2. The apparatus of claim 1, further comprising:
a synchronizer to identify boundaries of the OFDM symbols.

3. The apparatus of claim 1, further comprising:
an accumulator to accumulate the correlation output for a plurality of the OFDM symbols.

4. The apparatus of claim 3, wherein the correlator comprises:
a fast Fourier transform (FFT) engine.

5. The apparatus of claim 1, wherein:
the correlator generates frequency-domain representations of the one of the OFDM symbols and the cyclic prefix for the one of the OFDM symbols, generates a product of the frequency-domain representations; and generates a time-domain representation of the product.

6. The apparatus of claim 1, wherein:
a location of the apparatus is determined based upon the correlation output.

7. The apparatus of claim 1, further comprising:
a ranging unit to determine a location of the apparatus based upon the correlation output.

8. The apparatus of claim 1, further comprising:
a demodulator to demodulate the OFDM signal based upon the correlation output.

9. The apparatus of claim 1, wherein the OFDM signal comprises at least one of the group consisting of:
a European Telecommunications Standards Institute (ETSI) Digital Video Broadcasting-Terrestrial (DVB-T) signal;
a ETSI Digital Video Broadcasting-Handheld (DVB-H) signal; and
a Japanese Integrated Services Digital Broadcasting-Terrestrial (ISDB-T) signal.

10. A method comprising:
receiving an orthogonal frequency division modulation (OFDM) signal comprising a plurality of OFDM symbols each comprising N samples and a cyclic prefix comprising M of the N samples, wherein M<N;
storing the cyclic prefix for one of the OFDM symbols; and
generating a correlation output based on the cyclic prefix and the one of the OFDM symbols.

11. The method of claim 10, further comprising:
identifying boundaries of the OFDM symbols.

12. The method of claim 10, further comprising:
accumulating the correlation output for a plurality of the OFDM symbols.

13. The method of claim 10, wherein generating a correlation output based on the cyclic prefix and the one of the OFDM symbols comprises:
generating frequency-domain representations of the one of the OFDM symbols and the cyclic prefix for the one of the OFDM symbols;
generating a product of the frequency-domain representations; and
generating a time-domain representation of the product.

14. The method of claim 10, wherein:
a location is determined based upon the correlation output.

15. The method of claim 10, further comprising:
determining a location based upon the correlation output.

16. The method of claim 10, further comprising:
demodulating the OFDM signal based upon the correlation output.

17. The method of claim 10, wherein the OFDM signal comprises at least one of the group consisting of:
a European Telecommunications Standards Institute (ETSI) Digital Video Broadcasting-Terrestrial (DVB-T) signal;
a ETSI Digital Video Broadcasting-Handheld (DVB-H) signal; and
a Japanese Integrated Services Digital Broadcasting-Terrestrial (ISDB-T) signal.

18. An apparatus comprising:
front end means for receiving an orthogonal frequency division modulation (OFDM) signal comprising a plurality of OFDM symbols each comprising N samples and a cyclic prefix comprising M of the N samples, wherein M<N;
buffer means for storing the cyclic prefix for one of the OFDM symbols; and
correlator means for generating a correlation output based on the cyclic prefix and the one of the OFDM symbols.

19. The apparatus of claim 18, further comprising:
means for identifying boundaries of the OFDM symbols.

20. The apparatus of claim 18, further comprising:
means for accumulating the correlation output for a plurality of the OFDM symbols.

21. The apparatus of claim 20, wherein the correlator means comprises:
means for performing a fast Fourier transform (FFT).

22. The apparatus of claim 18, wherein:
the correlator means generates frequency-domain representations of the one of the OFDM symbols and the cyclic prefix for the one of the OFDM symbols, generates a product of the frequency-domain representations; and generates a time-domain representation of the product.

23. The apparatus of claim 18, wherein:
a location of the apparatus is determined based upon the correlation output.

24. The apparatus of claim 18, further comprising:
means for determining a location of the apparatus based upon the correlation output.

25. The apparatus of claim 18, further comprising:
means for demodulating the OFDM signal based upon the correlation output.

26. The apparatus of claim 18, wherein the OFDM signal comprises at least one of the group consisting of:
a European Telecommunications Standards Institute (ETSI) Digital Video Broadcasting-Terrestrial (DVB-T) signal;
a ETSI Digital Video Broadcasting-Handheld (DVB-H) signal; and
a Japanese Integrated Services Digital Broadcasting-Terrestrial (ISDB-T) signal.
